(19) United States
(12) Patent Application Publication
(10) Pub. No.: US 2026/0223002 A1
(43) Pub. Date: Jul. 30, 2026

(54) METHOD AND DEVICE FOR ACTIVATING WAKE-UP RECEIVER OF TERMINAL HAVING WAKE-UP RECEIVER IN WIRELESS COMMUNICATION SYSTEM

(71) Applicant: Samsung Electronics Co., Ltd., Suwon-si, Gyeonggi-do (KR)

(72) Inventors: Seunghoon CHOI, Suwon-si (KR); Youngbum KIM, Suwon-si (KR); Hyewon YANG, Suwon-si (KR); Jaewon LEE, Suwon-si (KR); Junyung YI, Suwon-si (KR)

(21) Appl. No.: 19/144,255

(22) PCT Filed: Jan. 5, 2024
(86) PCT No.: PCT/KR2024/000246

§ 371 Date: Jun. 27, 2025

(30) Foreign Application Priority Data
Jan. 6, 2023 (KR) 10-2023-0002357

(51) Int. Cl. H04W 52/02

(52) U.S. Cl. CPC H04W 52/028; H04W 52/0235

(57) ABSTRACT

The disclosure relates to a 5G or 6G communication system for supporting a higher data transmission rate. In addition, the present disclosure is for a wireless communication system, and relates to a method and apparatus for access link beam configuration for a network-controlled repeater in the wireless communication system.

### TECHNICAL FIELD

The present disclosure relates to a method and a device for activating or deactivating a wake-up receiver of a terminal having a wake-up receiver in a wireless communication system. Specifically, the present disclosure relates to a method and a device for activating and deactivating a wake-up receiver of a terminal having a wake-up receiver in order to solve the problem of excessive power consumption of the terminal and achieve high energy efficiency in a wireless communication system.

### BACKGROUND ART

5G mobile communication technologies define broad frequency bands such that high transmission rates and new services are possible, and may be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles on the basis of information regarding positions and states of vehicles transmitted by the vehicles and for enhancing user convenience, NR-U (New Radio Unlicensed) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services on the basis of UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next generation distributed computing technology for implementing services at levels of complexity exceeding the limit of UE operation capability by utilizing ultra-high-performance communication and computing resources.

As described above and with the development of wireless communication systems, a method for signal transmission of a terminal having a wake-up receiver is required to solve the problem of excessive terminal power consumption and achieve high energy efficiency.

### DISCLOSURE OF INVENTION

### Technical Problem

The present disclosure provides a method and a device for activating and deactivating a wake-up receiver of a terminal having a wake-up receiver to solve the problem of excessive terminal power consumption and achieve high energy efficiency in a wireless communication system.

### Solution to Problem

According to one embodiment of the present invention for achieving the above-described technical problem, a method performed by a terminal of a wireless communication system may include the steps of: receiving an activation signal for activating a wake-up receiver from a base station on the basis of a main radio (MR); transmitting a first response signal to the activation signal to the base station on the basis of the main radio; activating the wake-up receiver after transmitting the first response signal; and switching the main radio into a sleep state after transmitting the first response signal.

In addition, a terminal of a wireless communication system according to one embodiment of the present invention may include a transceiver; and a control unit configured to; receive an activation signal for activating a wake-up receiver from a base station on the basis of a main radio (MR); transmit a first response signal to the activation signal to the base station on the basis of the main radio; activate the wake-up receiver after transmitting the first response signal; and switch the main radio into a sleep state after transmitting the first response signal.

### Advantageous Effects of Invention

Various embodiments of the present disclosure may provide a device and a method capable of effectively providing a service in a wireless communication system.

The effects obtainable from the present disclosure are not limited to the effects mentioned in the various embodiments, and other effects not mentioned will be clearly understood by those skilled in the art to which the present disclosure belongs from the description below.

### BRIEF DESCRIPTION OF DRAWINGS

FIG. 1 illustrates the basic structure of a time-frequency resource domain in a wireless communication system according to various embodiments of the present disclosure.

FIG. 2 illustrates a time domain mapping structure and beam sweeping operation of a synchronization signal according to various embodiments of the present disclosure.

FIG. 3 illustrates a signal flow for random access (RA) according to various embodiments of the present disclosure.

FIG. 4 illustrates a signal flow for a terminal to report UE capability information to a base station according to various embodiments of the present disclosure.

FIG. 5 illustrates an example of state transitions between a base station and a terminal and a state of a terminal according to a base station state according to various embodiments of the present disclosure.

FIG. 6a illustrates an example for activating a wake-up receiver according to one embodiment of the present disclosure.

FIG. 6b illustrates another example for activating a wake-up receiver according to one embodiment of the present disclosure.

FIG. 6c illustrates another example for activating a wake-up receiver according to one embodiment of the present disclosure.

FIG. 7 illustrates an example for deactivating a wake-up receiver according to various embodiments of the present disclosure.

FIG. 8 illustrates an operation flow of a terminal activating or deactivating a wake-up receiver according to various embodiments of the present disclosure.

FIG. 9 illustrates an operational flow of a base station transmitting a signal for activating or deactivating a wake-up receiver according to various embodiments of the present disclosure.

FIG. 10 is a diagram illustrating the structure of a terminal in a wireless communication system according to various embodiments of the present disclosure.

FIG. 11 is a diagram illustrating the structure of a base station in a wireless communication system according to various embodiments of the present disclosure.

### MODE FOR THE INVENTION

The terms used in the present disclosure are only used to describe specific embodiments and may not be intended to limit the scope of other embodiments. The singular expression may include the plural expression unless the context clearly indicates otherwise. The terms used herein, including technical or scientific terms, may have the same meaning as commonly understood by a person of ordinary skill in the art described in the present disclosure. Among the terms used in the present disclosure, terms defined in general dictionaries may be interpreted as having the same or similar meaning as the meaning they have in the context of the related art and shall not be interpreted in an idealized or overly formal meaning unless explicitly defined in the present disclosure. In some cases, even if a term is defined in the present disclosure, it cannot be interpreted to exclude embodiments of the present disclosure.

In various embodiments of the present disclosure described below, a hardware-based approach is described as an example. However, since various embodiments of the present disclosure include techniques using both hardware and software, various embodiments of the present disclosure do not exclude software-based approaches.

Hereinafter, embodiments of the present disclosure will be described in detail with reference to the attached drawings. In addition, when describing the present disclosure, if it is determined that a specific description of a related known function or configuration may unnecessarily obscure the gist of the present disclosure, the detailed description thereof will be omitted. In addition, the terms described below are terms defined in consideration of the functions in the present disclosure, and these may vary depending on the intention or custom of the user or operator. Therefore, the definitions should be made on the basis of the contents throughout this specification.

The advantages and features of the present disclosure and methods for achieving them will become clear by reference to the embodiments described in detail below along with the accompanying drawings. However, the present disclosure is not limited to the embodiments disclosed below, but may be implemented in a variety of different forms and the present embodiments are merely provided to ensure that the disclosure of the present disclosure is complete and to fully inform the scope of the disclosure to persons of ordinary knowledge in the technical field to which the present disclosure pertains, and the present disclosure is only defined by the scope of the claims. Throughout the specification, the same reference numerals refer to the same components.

In this case, it will be understood that each block of the processing flowchart illustrations and combinations of the flowchart illustrations may be performed by computer program instructions. These computer program instructions may be mounted on a processor of a general purpose computer, a special purpose computer, or other programmable data processing equipment, such that the instructions, when executed by the processor of the computer or other programmable data processing equipment, create means for performing the functions described in the flowchart block(s). These computer program instructions may be stored in computer-usable or computer-readable memory that may be directed to a computer or other programmable data processing equipment to implement the functions in a specific manner, so that the instructions stored in the computer-usable or computer-readable memory may produce a manufactured item comprising instructional means for performing the functions described in the flowchart block(s). The computer program instructions may also be mounted on a computer or other programmable data processing equipment and a series of operational steps are performed on the computer or other programmable data processing equipment to create a computer-executable process, such that the instructions performing the computer or other programmable data processing equipment may also provide steps for performing the functions described in the flowchart block(s).

In addition, each block may represent a module, a segment, or a portion of code comprising one or more executable instructions for performing a specified logical function(s). It should also be noted that in some alternative embodiments, the functions recited in the blocks may occur out of sequence. For example, two blocks shown one after the other may in fact be performed substantially simultaneously, or the blocks may be performed in reverse order according to the functions they sometimes perform.

In this case, the term ‘~unit’ used in the present embodiment refers to software or a hardware component such as a Field Programmable Gate Array (FPGA) or Application Specific Integrated Circuit (ASIC), which may perform any of the roles. However, ‘~unit’ is not software or hardware specific. It may be configured to reside on an addressable storage medium, or it may be configured to execute one or more processors. Therefore, in one example, ‘~unit’ includes components such as software components, object-oriented software components, class components, and task components, processes, functions, properties, procedures, subroutines, segments of program code, drivers, firmware, microcode, circuits, data, databases, data structures, tables, arrays, and variables. The functionality provided within the components and ‘~units’ may be combined into fewer components and ‘~units’, or further separated into additional components and ‘~units’. Furthermore, the components and ‘~units’ may be implemented to play one or more CPUs within the device or the security multimedia card. In addition, in the embodiment, ‘~unit’ may include one or more processors.

In the following description of the present disclosure, if it is determined that a detailed description of a related known function or configuration may unnecessarily obscure the gist of the present disclosure, the detailed description thereof will be omitted. Hereinafter, an embodiment of the present disclosure will be described with reference to the attached drawings.

In the following description, terms used to identify access nodes, terms referring to network entities, terms referring to messages, terms referring to interfaces between network entities, terms referring to various identification information, etc. are examples for convenience of explanation. Therefore, the present disclosure is not limited to the terms described below, and other terms referring to objects having equivalent technical meanings may be used.

In the following description, the terms, physical channel and signal, may be used interchangeably with data or control signals. For example, physical downlink shared channel (PDSCH) is a term referring to a physical channel through which data is transmitted, but PDSCH may also be used to refer to data. That is, in the present disclosure, the expression ‘transmitting a physical channel’ may be interpreted equivalently to the expression ‘transmitting data or a signal through a physical channel’.

In the present disclosure below, upper layer signaling means a signal transmission method in which a base station transmits a signal to a terminal using a downlink data channel of a physical layer, or a terminal transmits a signal to a base station using an uplink data channel of a physical layer. Upper layer signaling may be understood as radio resource control (RRC) signaling or media access control (MAC) control element (CE).

In addition, although the present disclosure describes various embodiments using terms used in some communication standards (e.g., 3rd Generation Partnership Project (3GPP)), this is only an example for explanation. Various embodiments of the present disclosure may be easily modified and applied to other communication systems. In addition, the term, terminal, may represent not only cell phones, smart phones, IoT devices, and sensors, but also other wireless communication devices.

Hereinafter, the base station is an entity that performs resource allocation of a terminal, and may be at least one of a gNode B, a gNB, an eNode B, an eNB, a Node B, a Base Station (BS), a wireless access unit, a base station controller, or a node on a network. The terminal may include a User Equipment (UE), a Mobile Station (MS), a cellular phone, a smartphone, a computer, or a multimedia system capable of performing a communication function. Of course, they are not limited to the above examples. In addition, although various embodiments of the present disclosure are described below using a system on the basis of LTE, LTE-A, or NR as an example, various embodiments of the present disclosure may be applied to other communication systems having similar technical backgrounds or channel types. In addition, various embodiments of the present disclosure may be applied to other communication systems through some modifications without significantly departing from the scope thereof at the discretion of a person having skilled technical knowledge.

In order to handle the explosive increase in mobile data traffic, the initial standard of the 5th Generation (5G) system or New Radio (NR) access technology, which is the next-generation communication system after LTE (Long Term Evolution or Evolved Universal Terrestrial Radio Access (E-UTRA)) and LTE-A (LTE-Advanced or E-UTRA Evolution), has been completed. While the existing mobile communication systems have focused on existing voice/data communications, the 5G system aims to satisfy various services and requirements, such as enhanced Mobile BroadBand (eMBB) services for improving the existing voice/data communications, Ultra-Reliable and Low Latency Communication (URLLC) services, and massive Machine Type Communication (MTC) services that support large-scale machine-to-machine communications.

While the transmission bandwidth of a single carrier of the existing LTE and LTE-A systems is limited to a maximum of 20 MHz, the 5G system aims to provide ultra-high-speed data services of up to several Gbps by utilizing an ultra-wide bandwidth that is much wider than this. Accordingly, the 5G system is considering ultra-high frequency bands from several GHz to up to 100 GHz, where it is relatively easy to secure ultra-wide bandwidth frequencies, as candidate frequencies. Additionally, it is possible to secure wide bandwidth frequencies for the 5G system through frequency reallocation or allocation among frequency bands ranging from several hundred MHz to several GHz used in existing mobile communication systems.

Ultra-high frequency band radio waves have wavelengths of several millimeters and are also called millimeter waves (mmWave). However, in ultra-high frequency bands, the path loss of radio waves increases in proportion to the frequency band, so the coverage of mobile communication systems decreases.

Beamforming technology is applied to concentrate the radiated energy of radio waves to a predetermined target point using multiple antennas to increase the transmission distance of radio waves. In other words, the beam width of the signal to which beamforming technology is applied is relatively narrowed, and the radiated energy is concentrated within the narrowed beam width, thereby increasing the transmission distance. Beamforming technology may be applied to both the transmitter and the receiver. In addition to the effect of increasing coverage, beamforming technology has the effect of reducing interference in areas other than the beamforming direction. In order for beamforming technology to operate properly, accurate measurement and feedback methods of transmission/reception beams are required. Beamforming technology may be applied to a control channel or data channel that corresponds one-to-one between a predetermined terminal and a base station. In addition, beamforming technology may be applied to common signals transmitted by a base station to multiple terminals in the system, such as a synchronization signal, a physical broadcast channel (PBCH), a control channel for transmitting system information, and a data channel to increase coverage. When applying beamforming technology to a common signal, beam sweeping technology, which transmits a signal by changing the beam direction, is additionally applied so that the common signal can reach terminals located at any location within the cell.

Another requirement of the 5G system is an ultra-low latency service with a transmission delay of approximately 1 ms between the transmitter and receiver. One way to reduce the transmission delay is to design a frame structure on the basis of a short Transmission Time Interval (TTI) compared to LTE and LTE-A. TTI is a basic time unit for performing scheduling, and the TTI of the existing LTE and LTE-A systems is 1 ms corresponding to the length of one subframe. For example, in order to satisfy the requirement for the ultra-low latency service of the 5G system, a short TTI of 0.5 ms, 0.25 ms, or 0.125 ms, which are shorter than the existing LTE and LTE-A systems, are possible.

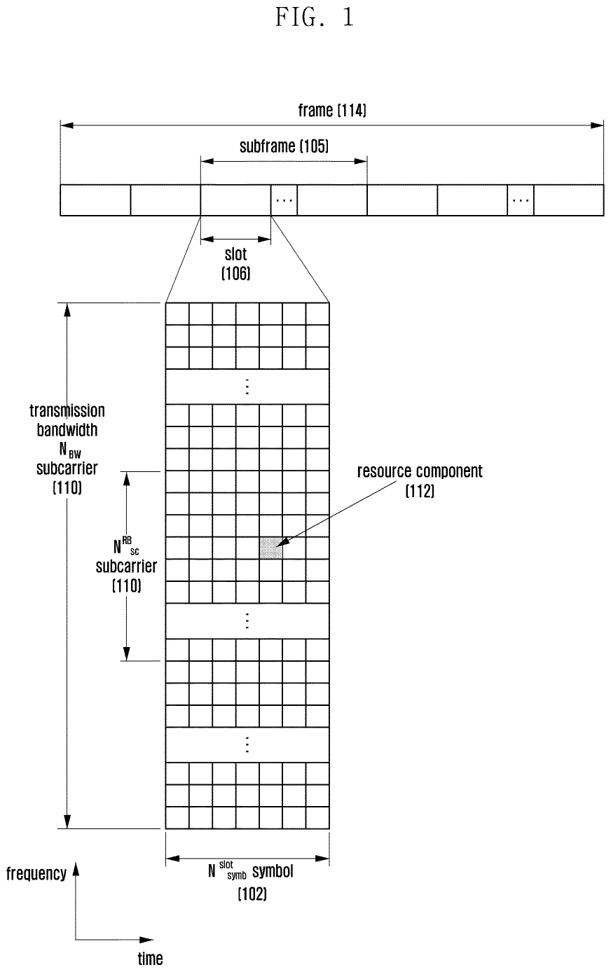

FIG. 1 illustrates a basic structure of a time-frequency resource domain in a wireless communication system according to various embodiments of the present disclosure. That is, FIG. 1 is a diagram illustrating a basic structure of a time-frequency resource domain, which is a wireless resource domain in which data or control channels of a 5G system are transmitted.

With reference to FIG. 1, the horizontal axis in FIG. 1 represents the time domain, and the vertical axis represents the frequency domain. The minimum transmission unit in the time domain of a wireless communication system is an Orthogonal Frequency Division Multiplexing (OFDM) symbol, in which

$${N}_{symb}^{slot}$$

symbols 102 may be grouped to form one slot 106,

$${N}_{s l o t}^{subframe}$$

slots may be grouped to form one subframe 105. The length of a subframe is 1.0 ms, and 10 subframes may be grouped to form a 10 ms frame 114. The minimum transmission unit in the frequency domain is a subcarrier, and the bandwidth of the entire system transmission bandwidth may be composed of a total of N_{BW} subcarriers 104.

In the time-frequency domain, the basic unit of resources is a Resource Element (RE) 112, which may be represented by an OFDM symbol index and a subcarrier index. A Resource Block (RB or Physical Resource Block, PRB) may be defined as

$${N}_{s c}^{RB}$$

consecutive subcarriers 110 in the frequency domain. In a 5G system,

$${N}_{sc}^{RB} = 12 ,$$

and the data rate may increase in proportion to the number of RBs scheduled to the terminal.

In a wireless communication system, a base station may map data in units of RBs and perform scheduling for RBs that generally constitute one slot for a predetermined terminal. That is, in a 5G system, the basic time unit in which scheduling is performed may be a slot, and the basic frequency unit in which scheduling is performed may be an RB.

The number of OFDM symbols

$${N}_{symb}^{slot}$$

is determined by the length of the cyclic prefix (CP) added to each symbol to prevent interference between symbols. For example, if the normal CP is applied,

$${N}_{symb}^{s l o t} = 14 ,$$

and if extended CP is applied,

$${N}_{symb}^{slot} = 12.$$

Extended CP is applied to a system in which the transmission distance is relatively longer than that of the normal CP and can maintain orthogonality between symbols. In the case of the normal CP, since the ratio of the CP length to the symbol length is maintained at a constant value, the overhead because of the CP may be maintained constant regardless of the subcarrier spacing. That is, if the subcarrier spacing is small, the symbol length becomes long, and thus the CP length may also become long. Conversely, if the subcarrier spacing is large, the symbol length becomes short, and thus the CP length may be reduced. The symbol length and the CP length may be inversely proportional to the subcarrier spacing.

In a wireless communication system, various frame structures may be supported by adjusting subcarrier spacing to satisfy various services and requirements. For example, from the viewpoint of an operating frequency band, a larger subcarrier spacing is advantageous for phase noise recovery in a high frequency band. From the viewpoint of transmission time, the larger the subcarrier spacing, the shorter the symbol length in the time domain, and consequently, a slot length is shortened, which is advantageous in supporting ultra-low latency services such as URLLC. From the viewpoint of cell size, a larger cell may be supported as the CP length is longer, and thus a smaller subcarrier spacing may support a relatively larger cell. A cell is a concept indicating an area covered by a single base station in mobile communication.

Subcarrier spacing, CP length, etc. are essential information for OFDM transmission and reception. The base station and terminal must recognize the subcarrier spacing, CP length, etc. as common values to enable smooth transmission and reception.

Table 1 below shows the relationship between the subcarrier spacing configuration (μ), subcarrier spacing (Δf), and CP length supported in the 5G system.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 2 below shows the number of symbols per slot

$$( {N}_{symb}^{s l o t} ) ,$$

the number of slots per frame

$$( {N}_{slot}^{frame , μ} ) ,$$

and the number of slots per subframe

$$( {N}_{slot}^{subframe \text{?}} )$$

$$\text{?} \text{indicates text missing or illegible when filed}$$

for each subcarrier spacing configuration (μ) for the normal CP.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 below shows the number of symbols per slot

$$( {N}_{symb}^{slot} ) ,$$

the number of slots per frame

$$( {N}_{slot}^{frame , μ} ) ,$$

and the number of slots per subframe

$$( {N}_{s l o t}^{subframe \text{?}} )$$

$$\text{?} \text{indicates text missing or illegible when filed}$$

for each subcarrier spacing configuration (μ) for the extended CP.

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

In the early stage of introduction of 5G system, coexistence or dual mode operation with existing LTE or/and LTE-A (hereinafter referred to as LTE/LTE-A) system was expected. As a result, existing LTE/LTE-A may provide stable system operation to terminals, and 5G system may perform the role of providing improved service to terminals. Therefore, the frame structure of 5G system needs to include at least the frame structure of LTE/LTE-A or essential parameter set (e.g., subcarrier spacing=15 kHz).

For example, when comparing a frame structure with a subcarrier spacing configuration μ=0 (hereinafter referred to as frame structure A) and a frame structure with a subcarrier spacing configuration μ=1 (hereinafter referred to as frame structure B), the frame structure B shows that the subcarrier spacing and RB size are twice large, and the slot length and symbol length are twice small, compared to the frame structure A. In the case of frame structure B, two slots may form one subframe, and 20 subframes may form one frame.

Generalizing the frame structure of the 5G system provides high scalability by ensuring that essential parameter sets such as subcarrier spacing, CP length, and slot length have integer multiple relationships for each frame structure. A subframe with a fixed length of 1 ms may be defined to represent a reference time unit that is independent of the frame structure.

The frame structure may be applied to correspond to various scenarios. From the perspective of cell size, since a longer CP length may support a larger cell, frame structure A can support a relatively larger cell than frame structure B. From the perspective of operating frequency band, a larger subcarrier spacing is advantageous for recovering phase noise in a high-frequency band, so frame structure B may support a relatively higher operating frequency than frame structure A. From the perspective of service, since a shorter slot length, which is the basic time unit of scheduling, is advantageous for supporting an ultra-low-delay service such as URLLC, frame structure B may be relatively more suitable for a URLLC service than frame structure A.

Hereinafter, in the description of the present disclosure, uplink (UL) may refer to a radio link in which a terminal transmits data or control signals to a base station, and downlink (DL) may refer to a radio link in which a base station transmits data or control signals to a terminal.

In the initial access stage where a terminal first accesses a system, the terminal may synchronize downlink time and frequency from a synchronization signal transmitted by a base station through cell search, and obtain a cell identifier (cell ID). The terminal may receive a Physical Broadcast Channel (PBCH) using the obtained cell ID, and obtain a Master Information Block (MIB), which is essential system information, from the PBCH. Additionally, the terminal may obtain cell-common transmission and reception-related control information by receiving system information (System Information Block, SIB) transmitted by the base station. The cell-common transmission and reception-related control information may include random access (RA)-related control information, paging-related control information, common control information for various physical channels, etc.

A synchronization signal is a signal that serves as a reference for cell search, and the subcarrier spacing may be applied to suit channel environments such as phase noise for each frequency band. In the case of a data channel or a control channel, the subcarrier spacing may be adaptively applied according to the service type in order to support various services as described above.

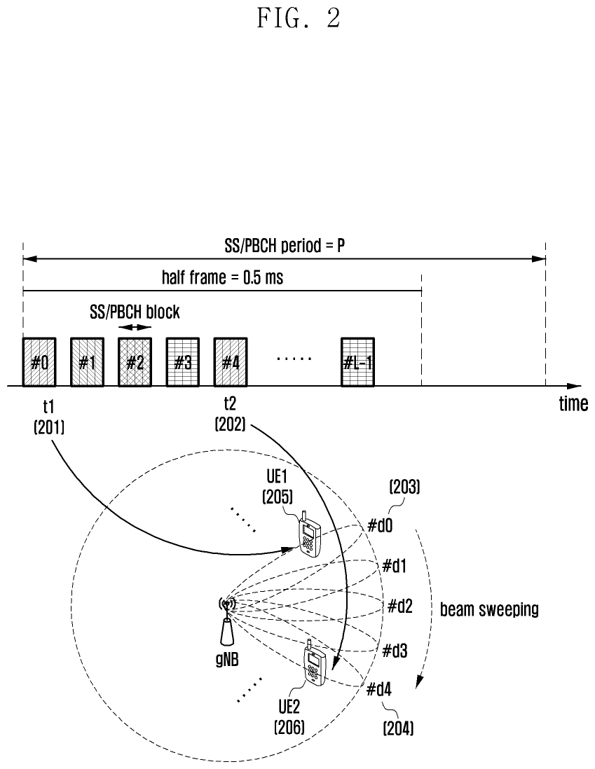

FIG. 2 illustrates a time domain mapping structure and beam sweeping operation of a synchronization signal according to various embodiments of the present disclosure.

Hereinafter, the following components may be predefined for the purpose of explaining the present disclosure.
Primary Synchronization Signal (PSS): It may serve as a reference for DL time/frequency synchronization and may provide some cell ID information.
Secondary Synchronization Signal (SSS): It may serve as a reference for DL time/frequency synchronization and may provide some of the remaining cell ID information. Additionally, it may serve as a reference signal for demodulation of PBCH.
Physical Broadcast Channel (PBCH): It may provide Master Information Block (MIB), which is essential system information required for transmission and reception of data channels and control channels of the terminal. Essential system information may include information such as search space-related control information indicating radio resource mapping information of the control channel, scheduling control information for a separate data channel transmitting system information, and System Frame Number (SFN), which is a frame unit index that serves as a timing reference.
SS/PBCH Block (Synchronization Signal/PBCH Block or SSB): An SS/PBCH block may be composed of N OFDM symbols and may include a combination of PSS, SSS, PBCH, etc. In a system to which beam sweeping technology is applied, an SS/PBCH block may be the minimum unit to which beam sweeping is applied. In a 5G system, N may be equal to 4. A base station may transmit up to L SS/PBCH blocks, and the L SS/PBCH blocks may be mapped within a half frame (0.5 ms). The L SS/PBCH blocks may be periodically repeated in units of a predetermined period P. The period P may be notified to a terminal by signaling from the base station. In the case that there is no separate signaling for the period P, the terminal may apply a predetermined default value.

With reference to FIG. 2, FIG. 2 shows an example in which beam sweeping is applied to SS/PBCH block units over time. With reference to FIG. 2, in the case of terminal 1 205, at time t1 201, a SS/PBCH block may be received using a beam radiated in the direction of #d0 203 by beamforming applied to SS/PBCH block #0. Terminal 2 206 may receive a SS/PBCH block using a beam radiated in the direction of #d4 204 by beamforming applied to SS/PBCH block #4 at time t2 202. The terminal may obtain an optimal synchronization signal through a beam radiated from the base station in the direction where the terminal is located. For example, it may be difficult for terminal 1 205 to obtain time/frequency synchronization and essential system information from an SS/PBCH block through a beam radiated in the direction of #d4, which is far from the location of terminal 1.

In addition to the initial access procedure, the terminal may receive an SS/PBCH block to determine whether the radio link quality of the current cell is maintained at a certain level or higher. In addition, in a handover procedure in which the terminal moves connection from the current cell to a neighboring cell, the terminal may receive an SS/PBCH block of the neighboring cell to determine the radio link quality of the neighboring cell and obtain time/frequency synchronization of the neighboring cell.

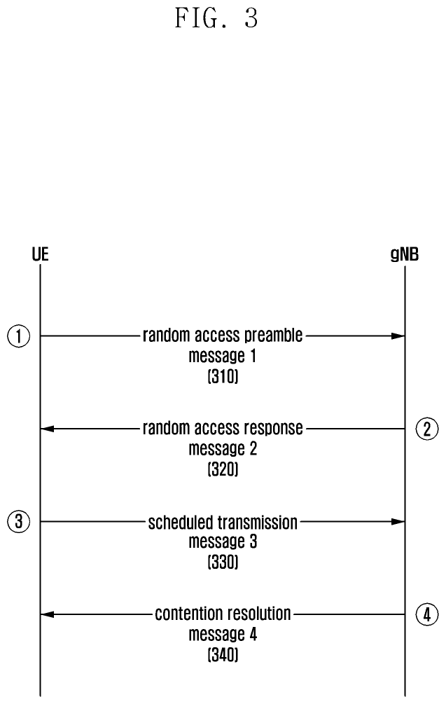

After the terminal obtains MIB and system information from the base station through the initial access procedure, the terminal may perform a random access procedure to switch the link with the base station into a connected state (or RRC_CONNECTED state). Upon completing the random access procedure, the terminal switches into a connected state, and one-to-one communication becomes possible between the base station and the terminal. The random access procedure will be described in detail with reference to FIG. 3 below.

FIG. 3 illustrates a signal flow for random access (RA) according to various embodiments of the present disclosure.

With reference to FIG. 3, in step 310, the terminal may transmit a random access preamble to the base station. The random access preamble, which is the first transmission message of the terminal in the random access procedure, may be referred to as message 1. The base station may measure a transmission delay value between the terminal and the base station from the random access preamble and synchronize uplink. At this time, the terminal may arbitrarily select which random access preamble to use within a random access preamble set predetermined by system information in advance. The initial transmission power of the random access preamble may be determined according to the path loss between the base station and the terminal measured by the terminal. In addition, the terminal may determine a transmission beam direction of the random access preamble from a synchronization signal received from the base station and transmit the random access preamble.

In step 320, the base station may transmit an uplink transmission timing adjustment command to the terminal on the basis of the transmission delay value measured from the random access preamble received in step 310. The base station may transmit an uplink resource and power control command to be used by the terminal to the terminal as scheduling information. The scheduling information transmitted by the base station may include control information for an uplink transmission beam of the terminal.

In the case that the terminal does not receive the Random Access Response (RAR) (or message 2), which is scheduling information for message 3, from the base station within a predetermined time in step 320, step 310 may be performed again. In the case that step 310 is performed again, the terminal may increase the probability of the base station receiving the random access preamble by increasing the transmission power of the random access preamble by a predetermined step and transmitting it (e.g., power ramping).

In step 330, the terminal may transmit uplink data (message 3) including its terminal ID to the base station using the uplink resources allocated in step 320. The terminal may transmit uplink data including the terminal ID to the base station through an uplink data channel (Physical Uplink Shared Channel, PUSCH). The transmission timing of the uplink data channel for transmitting message 3 may follow the timing control command received from the base station in step 320. The transmission power of the uplink data channel for transmitting the message 3 may be determined in consideration of the power control command received from the base station and the power ramping value of the random access preamble in step 320. Message 3 may mean the first uplink data signal that the terminal transmits to the base station after the terminal transmits the random access preamble.

In step 340, in the cast that the base station determines that the terminal has performed random access without collision with other terminals, the base station may transmit data (message 4) including the ID of the terminal that transmitted uplink data in step 330 to the terminal. In the case that the terminal receives the signal transmitted by the base station in step 340 from the base station, the terminal may determine that the random access is successful. The terminal may transmit Hybrid Automatic Repeat Request Acknowledgement (HARQ-ACK) information indicating whether message 4 has been successfully received to the base station through an uplink control channel (Physical Uplink Control Channel, PUCCH).

In the case that the data transmitted by the terminal in step 330 collides with data from another terminal and the base station fails to receive a data signal from the terminal, the base station may not transmit any more data to the terminal. In the case that the terminal fails to receive data transmitted from the base station in step 340 within a certain period of time, it may be determined that the random access procedure has failed, and the terminal may proceed again from step 310.

In the case that the terminal successfully completes the random access procedure, the terminal may be switched into a connected state, and one-to-one communication may be enabled between the base station and the terminal. The base station may receive UE capability information from the terminal in the connected state and adjust scheduling by referring to the UE capability information of the corresponding terminal. Through the UE capability information, the terminal may inform the base station of whether the terminal itself supports a predetermined function, the maximum allowable value of the function supported by the terminal, etc. Therefore, the UE capability information reported by each terminal to the base station may have different values for each terminal.

For example, a terminal may report UE capability information including at least one of the following control information to a base station.
Control information related to frequency bands supported by the terminal
Control information related to channel bandwidth supported by the terminal
Control information related to the maximum modulation method supported by the terminal
Control information related to the maximum number of beams supported by the terminal
Control information related to the maximum number of layers supported by the terminal
Control information related to CSI reporting supported by the terminal
Control information on whether the terminal supports frequency hopping
Bandwidth-related control information when supporting carrier aggregation (CA)
Control information on whether cross carrier scheduling is supported when supporting carrier aggregation

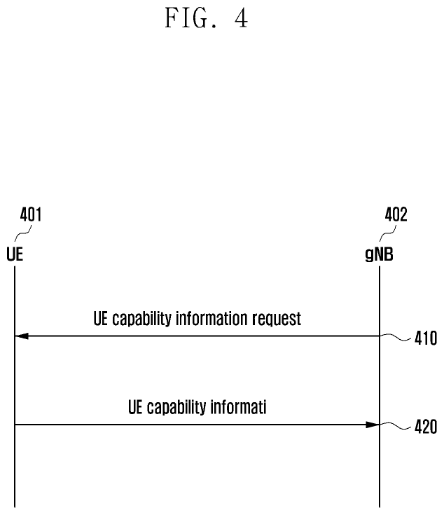

FIG. 4 illustrates a signal flow for a terminal to report UE capability information to a base station according to various embodiments of the present disclosure.

With reference to FIG. 4, in step 410, the base station 402 may transmit a UE capability information request message to the terminal 401. On the basis of the UE capability information request of the base station, the terminal may transmit UE capability information to the base station in step 420. According to one embodiment, the terminal may transmit UE capability information to the base station regardless of the UE capability information request of the base station.

On the basis of the process of transmitting and receiving UE capability information, a terminal connected to a base station may communicate one-to-one with the base station as a terminal in the RRC_CONNECTED state. Conversely, a terminal that is not connected may be in the RRC_IDLE state, and a terminal in the RRC_IDLE state may perform the following process.
Performing UE-specific DRX (Discontinuous Reception) cycles configured by the upper layer
Receiving paging messages from the core network
Obtaining system information
Measurement operation related to neighboring cells and cell reselection

In 5G systems, a new state of terminals called RRC_INACTIVE has been defined to reduce the energy and time consumed for initial access of the terminal. In addition to the operations performed by RRC_IDLE terminals, RRC_INACTIVE terminals may perform the following processes:
Storing access stratum (AS) information required for cell connection
UE-specific DRX cycle operation configured by RRC layer
Configuring and periodically updating RNA (radio access network (RAN)-based notification area) that can be utilized during handover by RRC layer
Monitoring RAN-based paging messages transmitted through inactive-radio network temporary identifier (I-RNTI)

The terminal in the RRC_CONNECTED state may change from RRC_CONNECTED to RRC_INACTIVE or RRC_IDLE state by receiving an RRC Release instruction from the base station.

The terminal in the RRC_INACITVE or RRC_IDLE state may change from RRC_INACTIVE or RRC_IDLE to RRC_CONNECTED state by performing random access and completing all random access procedures. The following describes a scheduling method by which a base station transmits downlink data to a terminal or instructs the terminal to transmit uplink data.

Downlink Control Information (DCI) may be control information that a base station transmits to a terminal through downlink. Downlink control information may include downlink data scheduling information or uplink data scheduling information for a predetermined terminal. In general, a base station may independently channel-code DCI for each terminal and then transmit it to each terminal through a downlink physical control channel, Physical Downlink Control Channel (PDCCH).

The base station may operate by applying a DCI format determined for the purpose of scheduling, such as whether it is scheduling information for downlink data (downlink assignment), scheduling information for uplink data (uplink grant), or DCI for power control.

The base station may transmit downlink data to the terminal through the Physical Downlink Shared Channel (PDSCH), which is a physical channel for downlink data transmission. The base station may inform the terminal of scheduling information such as specific mapping positions in the time and frequency domains of the PDSCH, modulation methods, HARQ-related control information, and power control information through DCI related to downlink data scheduling information among DCIs transmitted through the PDCCH.

The terminal may transmit uplink data to the base station through the Physical Uplink Shared Channel (PUSCH), which is a physical channel for uplink data transmission. The base station may inform the terminal of scheduling information such as specific mapping positions in the time and frequency domains of the PUSCH, modulation methods, HARQ-related control information, and power control information through DCI related to uplink data scheduling information among DCIs transmitted through the PDCCH.

The time-frequency resource to which the PDCCH is mapped may be referred to as a control resource set (CORESET). The CORESET may be configured to all or some of the frequency resources of the bandwidth supported by the terminal in the frequency domain. In the time domain, it may be configured to one or more OFDM symbols, which may be defined as the CORESET length (Control Resource Set Duration). The base station may configure one or more CORESETs to the terminal through upper layer signaling (e.g., System Information, Master Information Block (MIB), Radio Resource Control (RRC) signaling). When the base station configures a CORESET to the terminal, it may mean that the base station provides the terminal with information such as a CORESET identifier (Identity), a frequency location of the CORESET, and a symbol length of the CORESET. The information that the base station provides to the terminal to configure the CORESET may include at least some of the information included in Table 4 below.

TABLE 4

| | |
|---|---|
| ControlResourceSet ::= | SEQUENCE { |
| controlResourceSetId | ControlResourceSetId, |
| frequencyDomainResources | BIT STRING (SIZE (45)), |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| interleaverSize | ENUMERATED {n2, n3, n6}, |

| | |
|---|---|
| shiftIndex | INTEGER(0..maxNrofPhysicalResourceBlocks-1) |

OPTIONAL -- Need S
},

| | |
|---|---|
| nonInterleaved | NULL |

},

| | |
|---|---|
| precoderGranularity | ENUMERATED {sameAsREG-bundle, allContiguousRBs}, |

| | |
|---|---|
| tci-StatesPDCCH-ToAddList | SEQUENCE(SIZE (1..maxNrofTCI-StatesPDCCH)) |

OF TCI-StateId OPTIONAL, -- Cond NotSIB1-initialBWP

| | |
|---|---|
| tci-StatesPDCCH-ToReleaseList | SEQUENCE(SIZE (1..maxNrofTCI- |

StatesPDCCH)) OF TCI-StateId OPTIONAL, -- Cond NotSIB1-initialBWP

| | | |
|---|---|---|
| tci-PresentInDCI | ENUMERATED {enabled} | OPTIONAL, |

-- Need S

| | | |
|---|---|---|
| pdcch-DMRS-ScramblingID | INTEGER (0..65535) | OPTIONAL, |

-- Need S
...
}

A CORESET may be composed of

$${N}_{R B}^{CORESET}$$

RBs in frequency domain and

$${N}_{symb}^{CORESET} ∈ \{ 1 , 2 , 3 \}$$

symbols in time domain. An NR PDCCH may be composed of one or more Control Channel Elements (CCEs). One CCE may be composed of six Resource Element Groups (REGs), and an REG may be defined as 1 RB during 1 OFDM symbol. Within a CORESET, REGs may be indexed in time-first order, starting with REG index 0 from the first OFDM symbol of the CORESET, the lowest RB.

Interleaved and non-interleaved transmission methods for PDCCH may be supported. The base station may configure to the terminal whether interleaved or non-interleaved transmission is performed for each CORESET through upper layer signaling. Interleaved method may be performed in units of REG bundles. A REG bundle may be defined as a set of one or more REGs. The terminal may determine the CCE-to-REG mapping method in the corresponding CORESET on the basis of whether interleaved or non-interleaved transmission configured by the base station as shown in Table 5 below.

```
TABLE 5
The CCE-to-REG mapping for a control-resource set can be interleaved or non-interleaved and is
described by REG bundles:
  REG bundle i is defined as REGs {iL, iL + 1, . . . , iL + L − 1} where L is the REG bundle size, i =
  $0 , 1 , … , {N}_{REG}^{CORESET} / L - 1 , and {N}_{REG}^{CORESET} = {N}_{RB}^{CORESET} {N}_{symb}^{CORESET} is the number of REGs in the CORESET$
  CCE j consists of REG bundles {f(6j/L), f(6j/L + 1), . . . , f(6j/L + 6/L − 1)} where f(−) is an
  interleaver
For non-interleaved CCE-to-REG mapping, L = 6 and f (x) = x.
$For interleaved CCE - to - REG mapping , L ∈ \{ 2 , 6 \} for {N}_{symb}^{CORESET} = 1 and L ∈ \{ {N}_{symb}^{CORESET} , 6 \} for$
${N}_{symb}^{CORESET} ∈ \{ 2 , 3 \} . The interleaver is defined by$
      $f ( x ) = ( rC + c + {n}_{shift} ) mod ( {N}_{REG}^{CORESET} / L )$
          x = xR + r
        r = 0, 1, . . . , R − 1
        c = 0, 1, . . . , C − 1
        $C = {N}_{REG}^{CORESET} / ( LR )$
where R ∈ {2, 3, 6}.
```

The base station may inform the terminal of configuration information, such as information on a symbol to which the PDCCH is mapped in the slot, and a transmission period, through signaling.

The search space of the PDCCH is described as follows. The number of CCEs required to transmit the PDCCH may be 1, 2, 4, 8, or 16 depending on the aggregation level (AL), and different numbers of CCEs may be used for link adaptation of the downlink control channel. For example, when AL=L, one downlink control channel may be transmitted through L CCEs. The terminal performs blind decoding to detect a signal without knowing information about the downlink control channel, and for this purpose, a search space representing a set of CCEs may be defined. The search space is a set of downlink control channel candidates consisting of CCEs that the terminal should attempt to decode on a predetermined aggregation level, and since there are various aggregation levels that form one bundle with 1, 2, 4, 8, or 16 CCEs, the terminal may have multiple search spaces. A search space set may be defined as the collection of search spaces at all configured aggregation levels.

The search space may be classified into a common search space (CSS) and a UE-specific search space (USS). A certain group of terminals or all terminals may search the common search space of the PDCCH to receive cell-common control information such as dynamic scheduling for system information (SIB) or paging messages. For example, a terminal may receive scheduling allocation information of a PDSCH for receiving system information by searching the common search space of the PDCCH. In the case of the common search space, since a certain group of terminals or all terminals must receive the PDCCH, it may be defined as a set of predetermined CCEs. The terminal may receive scheduling allocation information for a UE-specific PDSCH or PUSCH by searching the UE-specific search space of the PDCCH. The UE-specific search space may be defined UE-specifically as a function of the terminal's ID (Identity) and various system parameters.

The base station may configure the search space configuration information of the PDCCH to the terminal through upper layer signaling (e.g., SIB, MIB, RRC signaling). For example, the base station may configure the number of PDCCH candidates in each aggregation level L, the monitoring period for the search space, the monitoring occasion for each symbol in the slot for the search space, the search space type (common search space or UE-specific search space), the combination of DCI format and RNTI to be monitored in the corresponding search space, the CORESET index to be monitored for the search space, etc. to the terminal. For example, the parameters for the search space for the PDCCH may include information such as the following Table 6.

TABLE 6
SearchSpace ::= SEQUENCE {
searchSpaceId SearchSpaceId,
controlResourceSetId ControlResourceSetId OPTIONAL, -- Cond SetupOnly
monitoringSlotPeriodicityAndOffset CHOICE {
sl1 NULL,
sl2 INTEGER (0..1),
sl4 INTEGER (0..3),
sl5 INTEGER (0..4),
sl8 INTEGER (0..7),
sl10 INTEGER (0..9),
sl16 INTEGER (0..15),
sl20 INTEGER (0..19),
sl40 INTEGER (0..39),
sl80 INTEGER (0..79),
sl160 INTEGER (0..159),
sl320 INTEGER (0..319),
sl640 INTEGER (0..639),
sl1280 INTEGER (0..1279),
sl2560 INTEGER (0..2559)
} OPTIONAL, -- Cond Setup
duration INTEGER (2..2559) OPTIONAL, -- Need S
monitoringSymbolsWithinSlot BIT STRING (SIZE (14)) OPTIONAL, -- Cond Setup
nrofCandidates SEQUENCE {
aggregationLevel1 ENUMERATED {n0, n1, n2, n3, n4, n5, n6, n8},
aggregationLevel2 ENUMERATED {n0, n1, n2, n3, n4, n5, n6, n8},
aggregationLevel4 ENUMERATED {n0, n1, n2, n3, n4, n5, n6, n8},
aggregationLevel8 ENUMERATED {n0, n1, n2, n3, n4, n5, n6, n8},
aggregationLevel16 ENUMERATED {n0, n1, n2, n3, n4, n5, n6, n8}
} OPTIONAL, -- Cond Setup
searchSpaceType CHOICE {
common SEQUENCE {
dci-Format0-0-AndFormat1-0 SEQUENCE {
...
} OPTIONAL, -- Need R
dci-Format2-0 SEQUENCE {
nrofCandidates-SFI SEQUENCE {
aggregationLevel1 ENUMERATED {n1, n2} OPTIONAL, -- Need R
aggregationLevel2 ENUMERATED {n1, n2} OPTIONAL, -- Need R
aggregationLevel4 ENUMERATED {n1, n2} OPTIONAL, -- Need R
aggregationLevel8 ENUMERATED {n1, n2} OPTIONAL, -- Need R
aggregationLevel16 ENUMERATED {n1, n2} OPTIONAL -- Need R
},
...
} OPTIONAL, -- Need R
dci-Format2-1 SEQUENCE {
...
} OPTIONAL, -- Need R
dci-Format2-2 SEQUENCE {
...
} OPTIONAL, -- Need R
dci-Format2-3 SEQUENCE {
dummy1 ENUMERATED {sl1, sl2, sl4, sl5, sl8, sl10, sl16, sl20} OPTIONAL, -- C
ond Setup
dummy2 ENUMERATED {n1, n2},
...
} OPTIONAL -- Need R
},
ue-Specific SEQUENCE {
dci-Formats ENUMERATED {formats0-0-And-1-0, formats0-1-And-1-1},
...
}
} OPTIONAL -- Cond Setup
}

On the basis of the configuration information transmitted to the terminal, the base station may configure one or more search space sets for the terminal. According to one embodiment, the base station may configure search space set 1 and search space set 2 for the terminal. In search space set 1, the terminal may be configured to monitor DCI format A scrambled with X-RNTI in a common search space, and in search space set 2, the terminal may be configured to monitor DCI format B scrambled with Y-RNTI in a UE-specific search space.

According to the configuration information transmitted by the base station, one or more search space sets may exist in the common search space or the UE-specific search space. For example, search space set #1 and search space set #2 may be configured as the common search space, and search space set #3 and search space set #4 may be configured as the UE-specific search space.

In a common search space, a terminal may monitor the following combinations of DCI formats and RNTIs. According to various embodiments of the present disclosure, of course, they are not limited to the examples below.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In a UE-specific search space, a terminal may monitor the following combinations of DCI formats and RNTIs. According to various embodiments of the present disclosure, of course, they are not limited to the examples below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

RNTIs may follow the following definitions and uses. According to various embodiments of the present disclosure, of course, they are not limited to the examples below.
C-RNTI (Cell RNTI): Used for UE-specific PDSCH or PUSCH scheduling
TC-RNTI (Temporary Cell RNTI): Used for UE-specific PDSCH scheduling
CS-RNTI (Configured Scheduling RNTI): Used for semi-statically configured UE-specific PDSCH scheduling
RA-RNTI (Random Access RNTI): Used for PDSCH scheduling in the random access phase
P-RNTI (Paging RNTI): Used for PDSCH scheduling where paging is transmitted
SI-RNTI (System Information RNTI): Used for PDSCH scheduling where system information is transmitted
INT-RNTI (Interruption RNTI): Used to indicate whether puncturing has been applied to the PDSCH
TPC-PUSCH-RNTI (Transmit Power Control for PUSCH RNTI): Used to indicate power control commands to PUSCH
TPC-PUCCH-RNTI (Transmit Power Control for PUCCH RNTI): Used to indicate power control commands to PUCCH
TPC-SRS-RNTI (Transmit Power Control for SRS RNTI): Used to indicate power control commands to SRS

The DCI formats described above may follow the definitions shown in Table 7 below.

TABLE 7

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands for |
| | SRS transmissions by one or more UEs |

The search space of the aggregation level L in the CORESET p and the search space set s may be expressed as the following equation 1.

$$L \cdot \{ ( {Y}_{p , {n}_{s , f}^{μ}} + ⌊ \frac{{m}_{s , {n}_{CI}} \cdot {N}_{C CE , p}}{L \cdot {M}_{p , s , max}^{( L )}} ⌋ + {n}_{CI} ) mod ⌊ {N}_{CCE , p} / L ⌋ \} + i \qquad Equation 1$$

L: Aggregation level
nCI: Carrier index
NCCE,p: Total number of CCEs existing in the control resource set p
nμs,f: Slot index
M(L)p,s,max: Number of PDCCH candidates for aggregation level L
msnCI=0, . . . , M(L)p,s,max−1: Index of PDCCH candidates for aggregation level L

$$i = 0 , … , L - 1$$

$${Y}_{p , {n}_{s , f}^{μ}} = ( {A}_{p} \cdot {Y}_{p , {n}_{s , f}^{μ} - 1} ) mod D , {Y}_{p , - 1} = {n}_{RNTI} \neq 0 , {A}_{0} = 398 \; 27 ,$$

$${A}_{1} = 39829 , {A}_{2} = 39839 , D = 65537$$

nRNTI: Terminal identifier

The value

$${Y}_{p , {n}_{s , f}^{μ}}$$

may correspond to 0 in the case of a common search space.

In the case of a UE-specific search space, the value

$${Y}_{p , {n}_{s , f}^{μ}}$$

may correspond to a value that changes depending on the terminal's ID (C-RNTI or ID configured for the terminal by the base station) and the time index.

As described above, in order to achieve ultra-high-speed data services reaching several Gbps in the 5G system, ultra-wide bandwidth signal transmission and reception of tens to hundreds of MHz or several GHz may be supported. Ultra-wide bandwidth signal transmission and reception may be supported through a single component carrier (CC) or through carrier aggregation (CA) technology that combines multiple component carriers. When a mobile communication service provider cannot secure a frequency with a sufficient bandwidth to provide ultra-high-speed data services with a single component carrier, the carrier aggregation technology may increase the sum of the frequency bandwidth by combining each component carrier having a relatively small bandwidth size, thereby enabling ultra-high-speed data services.

5G systems are designed and developed for a variety of use cases. In addition to standby time, reliability, and availability, energy efficiency of the terminal is also very important for 5G. Current 5G terminals require charging on a weekly or daily basis depending on the usage time of the individual and typically consume tens of mW in RRC_IDLE/RRC_INACTIVE states and hundreds of mW in RRC_CONNECTED states. Designing for extended battery life may be essential for improving energy efficiency as well as improving user experience. Energy efficiency may be even more important for terminals that do not have a continuous energy source (e.g., terminals using small rechargeable battery and single coin cell battery). Among 5G use cases, sensors and actuators are widely deployed for monitoring, measuring, and charging, and the batteries are generally non-rechargeable and require a battery life of at least several years. Wearables may also include smartwatches, rings, eHealth-related devices, and medical monitoring devices, which are generally difficult to last for up to 1-2 weeks depending on the usage time.

As an example of a commercial 5G terminal, the power consumption of the 5G terminal depends on the configured length of the wake-up periods (e.g., paging cycle), and a large extended discontinuous reception (eDRX) cycle may be used to meet the battery life requirement. However, the eDRX method is not suitable for low latency services because it maintains a long battery life on the basis of high latency. For example, in a fire detection and extinguishing use case, the fire shutter may need to be closed and the sprinkler may need to be turned on by the actuator within 1-2 seconds from the time a fire is detected by a sensor. In this case, the latency may be critical, and a long eDRX cycle as in the past is not suitable because it cannot meet the latency requirement.

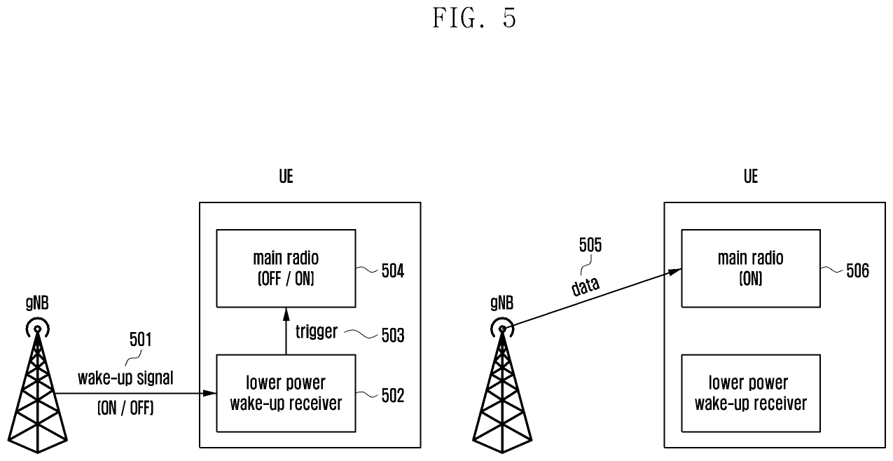

FIG. 5 illustrates an example of state transitions between a base station and a terminal and a state of a terminal according to a base station state according to various embodiments of the present disclosure. Specifically, FIG. 5 illustrates state transitions of a base station and a terminal for solving the above-described problem.

Current commercial 5G terminals may require periodic wake-up once per eDRX cycle, which can dominate the power consumption during periods of no signaling or data traffic. Power consumption may be dramatically reduced if the terminals can wake up only when triggered, such as by paging. The breakthrough power reduction may be achieved by triggering the main radio (e.g., existing NR radio or main radio, MR) using a wake-up signal (WUS), as shown in FIG. 5, and using a separate receiver, the wake-up receiver (WUR or lower power receiver, LR), which can monitor the WUS at ultra-low power, to turn on the main radio only when data transmission and reception are required.

According to one embodiment, in step 501, the base station may transmit a WUS corresponding to ON or OFF to the terminal.

In step 502, the terminal may receive the WUS using WUR.

In step 503, the terminal may trigger the main radio in the OFF or ON state on the basis of the information that the received signal corresponds to ON or OFF.

In step 504, the terminal may configure the main radio to wake up or turn off. According to one embodiment, it may be configured to a deep sleep (DS) or ultra-deep sleep (UDS) state rather than completely OFF.

According to one embodiment, in the case that data traffic to be transmitted from a base station to a terminal occurs 505 and the WUS transmitted by the base station in step 501 is a signal corresponding to ON, the main radio may be ON, and the terminal may receive the data transmitted by the base station through the main radio, not the WUR 506.

According to one embodiment, the power consumption for monitoring the WUS depends on the hardware modules of the WUR used for WUS design, signal detection and processing, so that the gains will be maximized for power-sensitive and small form factor devices including IoT use cases (such as industrial sensors, controllers) and wearables.

According to one embodiment, a terminal including a wake-up receiver may report to a base station that it has the capability to wake up the main radio using the wake-up receiver or may report capability information to the base station that the terminal includes a wake-up receiver.

According to one embodiment, the terminal may also report capability information about the wake-up receiver to the base station through the UE capability information reporting procedure of FIG. 4.

According to one embodiment, the terminal may report capability information about the wake-up receiver to the base station through at least one step of the random access preamble or the uplink data channel in the random access procedure of FIG. 3. According to one embodiment, sets of random access preambles that the terminal including the wake-up receiver can transmit may be transmitted to the terminal as system information. The terminal may select a random access preamble from the set received by the terminal, and transmit the random access preamble on the basis of the selected random access preamble in step 310 of the random access procedure of FIG. 3. According to one embodiment, after reporting capability information about the wake-up receiver to the base station, the terminal may receive information indicating whether to use the wake-up receiver from the base station through upper layer signaling or a physical signal.

According to one embodiment, when a base station supports a terminal including a wake-up receiver (e.g., when the base station has hardware capable of transmitting a wake-up signal), the base station may determine whether to use the wake-up receiver after receiving capability information about the wake-up receiver from the terminal. According to one embodiment, the base station may transmit a signal instructing the terminal whether to use the wake-up receiver or configuration information for reception of the wake-up signal. According to one embodiment, the base station may transmit to the terminal at least one of instruction information activating terminal reception of the wake-up signal or instruction information notifying that the base station transmits the wake-up signal. From a slot in which the signal is received, the terminal may turn off the main radio after a slot defined in the standard or configured by the base station, and turn on the wake-up receiver for monitoring the wake-up signal. According to one embodiment, the terminal may transmit to the base station at least one of feedback that it has received a signal indicating whether to use the wake-up receiver before turning off the main radio, or feedback that the main radio has been turned off and the wake-up receiver has been turned on.

According to one embodiment, in the case that the base station does not support a terminal having a wake-up receiver, the base station may receive capability information about the wake-up receiver from the terminal, and then transmit a signal to the terminal indicating that the wake-up receiver is unusable. The terminal may transmit feedback to the base station that it has received the signal indicating that the wake-up receiver is unusable. According to one embodiment, the terminal may perform an operation according to parameters of the existing power saving method configured by the base station by using an existing power saving method (C-DRX or I-DRX such as paging).

According to various embodiments of the present disclosure, after a capability report of a terminal having a wake-up receiver and a procedure for whether the wake-up receiver is supported (or permitted) from a base station, the wake-up receiver of the terminal may perform an operation of turning on and off a main radio of the terminal by receiving a wake-up signal. According to one embodiment, it goes without saying that the terminal may independently perform the operation of turning on/off the main radio and the operation of reporting the capability of the terminal having the wake-up receiver, or the operation procedures for whether the wake-up receiver is supported from the base station. For example, even when the capability report operation and the permission procedure of the terminal are not performed, the base station may transmit a signal to the terminal indicating whether to use the wake-up receiver or configuration information for receiving the wake-up signal, and accordingly, a terminal having a wake-up receiver among the terminals receiving a signal from the base station may perform an operation of turning on/off the main radio through the wake-up receiver. According to one embodiment, after the capability report operation of the terminal and the base station authorization procedure are performed, the operation of turning on/off the main radio through the wake-up receiver may be applied to all terminals within a cell supported by the base station (e.g., RRC_CONNECTED terminals, RRC_IDLE/RRC_INACTIVE terminals, or terminals accessing a cell (e.g., RRC_CONNECTED terminals)). If the capability report operation of the terminal and the base station authorization procedure are not performed, the operation of turning on/off the main radio through the wake-up receiver may be applied to RRC_IDLE/RRC_INACTIVE terminals camping within a cell supported by the base station. In addition, various embodiments of the present disclosure may include at least one of all, some, or a combination of some of the various operations of a terminal and a base station including a wake-up receiver as disclosed below.

Hereinafter, according to various embodiments of the present disclosure, an operation of turning on and off a main radio of a terminal having a wake-up receiver is described. Various embodiments of the present disclosure may include at least one of all, some, or a combination of some of the various operations of a terminal and a base station including a wake-up receiver as disclosed below.

According to one embodiment, when the main radio of the terminal is on, the terminal may receive a downlink signal (or data) from the base station through the main radio. According to various embodiments of the present disclosure, the main radio being ‘on’ may be expressed as the main radio being ‘turned on’ or the main radio being ‘activated’ and, without being limited thereto, may be represented by similar or substantially equivalent meanings. According to one embodiment, the main radio being activated may mean that specific components of the main radio (e.g., radio frequency (RF) or baseband (BB), etc.) are turned on or activated, or may be defined by a standard (e.g., 3GPP TS document). However, according to various embodiments of the present disclosure, without being limited to the above, the main radio being activated may include performing an operation by a parameter or parameter having equivalent or substantially similar content thereto. Alternatively, it may include the main radio performing reception operations of specific channels or signals (e.g., SS/PBCH blocks containing synchronization signals or PDCCHs containing downlink control channels) as defined in the 3GPP TS document.

According to one embodiment, when the main radio of the terminal is off, the terminal may be regarded as being in a sleep period or may not receive a downlink signal (or data) from the base station. According to various embodiments of the present disclosure, the main radio being ‘off may be expressed as the main radio being’ ‘turned off’ or the main radio being ‘deactivated’ and, without being limited thereto, may be represented by similar or substantially equivalent meanings. According to one embodiment, the main radio being deactivated may mean that specific components of the main radio (e.g., radio frequency (RF) or baseband (BB), etc.) are turned off or deactivated, or may be defined by a standard (e.g., 3GPP TS document). However, according to various embodiments of the present disclosure, without being limited to the above, the main radio being deactivated may include performing an operation by a parameter or parameter having equivalent or substantially similar content thereto. Alternatively, it may include the main radio no longer performing reception operations on specific channels or signals (e.g., SS/PBCH blocks containing synchronization signals or PDCCH containing downlink control channels) as defined in the 3GPP TS document.

According to various embodiments of the present disclosure, when a base station has a channel or signal to be transmitted to a terminal, the base station may transmit a wake-up signal to the terminal. The terminal or the wake-up receiver may receive the wake-up signal to turn on the main radio. According to one embodiment, the operation of receiving the wake-up signal itself may be an instruction to wake up the main radio. According to one embodiment, the wake-up signal may include K information bits, and information to wake up the main radio may be mapped to the K information bits. For example, when the information bit included in the wake-up signal is 1 bit of information, ‘1’ may indicate ON and ‘0’ may indicate OFF.

According to one embodiment, from a base station transmission perspective, it may be predefined whether a wake-up signal will be transmitted at some point before transmission of a channel or signal. From a terminal reception perspective, it may also be predefined whether a wake-up signal can be received at some point before reception of a channel or signal.

According to one embodiment, the terminal may transmit to the base station information about the time offset required between the wake-up signal and the transmission of the channel/signal, and the base station may configure the time offset between the wake-up signal and the transmission of the channel/signal to the terminal on the basis of the received information. According to one embodiment, the terminal may transmit to the base station information about the time offset required between the wake-up signal and the transmission of the channel/signal through the UE capability information reporting procedure, or may transmit to the base station through a random access preamble or an uplink data channel in a random access procedure. Of course, without being limited thereto, the terminal may transmit the information about the time offset to the base station through an upper layer signal or through various signals. The base station may configure the information about the time offset between the wake-up signal and the transmission of the channel/signal to the terminal through a downlink data channel of a random access response (e.g., message 2) or a random access contention resolution (e.g., message 4) in a random access procedure. Of course, without being limited thereto, the base station may configure the information about the time offset to the terminal through an upper layer signal or through various signals.

According to various embodiments of the present disclosure, when a base station has a periodic channel or periodic signal to transmit to a terminal, instead of the base station transmitting a wake-up signal every time when there is a channel or signal to transmit, the terminal or wake-up receiver may turn on the main radio according to a period according to configuration information of the periodic channel or periodic signal configured by the base station.

According to one embodiment, a base station may transmit the wake-up signal only during the first transmission of the periodic channel or periodic signal and may omit transmission of the wake-up signal during subsequent repeated transmissions of the channel or signal. In this case, the terminal or wake-up receiver may turn on the main radio on the basis of periodic signal configured by the base station or the period according to the configuration information of the periodic channel.

According to one embodiment, the type of periodic channel or periodic signal transmitted and received between the base station and the terminal may be predefined. According to one embodiment, the type of periodic channel or periodic signal may be configured by the base station. The base station may configure the type of periodic channel or periodic signal to the terminal through a downlink data channel of a random access response (e.g., message 2) or a random access contention resolution (e.g., message 4), or may configure it to the terminal through an upper layer signal indicating configuration information for reception of a wake-up signal or another upper layer signal.

According to various embodiments of the present disclosure, when a terminal has a channel or signal to transmit to a base station (e.g., a Physical Random Access Channel (PRACH) or a Scheduling Request (SR) or a Buffer Status Report (BSR)) or when the terminal performs L1/L3-based measurement, the terminal or the wake-up receiver may turn on the main radio regardless of the wake-up signal transmitted by the base station.

According to one embodiment, a wake-up receiver may receive a wake-up signal for uplink transmission or L1/L3 based measurement transmitted by a terminal to a base station and may not apply the operation of turning on and off the main radio of the terminal.

According to one embodiment, the type of the uplink channel or the uplink signal or the L1/L3-based measurement of the terminal transmitted regardless of the reception operation of the wake-up signal, may be predefined. According to one embodiment, the type of the uplink channel or the uplink signal or the L1/L3-based measurement may be configured by the base station. The base station may configure the type of the uplink channel or the uplink signal or the L1/L3-based measurement to the terminal through a random access response (e.g., message 2) or a random access contention resolution (e.g., message 4) downlink data channel, or may configure it to the terminal through an upper layer signal indicating configuration information for reception of the wake-up signal or another upper layer signal.

Hereinafter, according to various embodiments of the present disclosure, an operation for turning off the main radio when the main radio is in an on state is described. According to one embodiment, the operation for waking up the main radio when the main radio is in an on state may be performed in combination with various operations according to various embodiments of the present disclosure, or may be performed separately, and may not be an essential component.

According to various embodiments of the present disclosure, a base station may transmit a sleep signal to a terminal when there is no channel or signal to be transmitted to the terminal. The terminal or the wake-up receiver may receive the sleep signal to turn off the main radio. According to one embodiment, the operation of receiving the sleep signal itself may be an instruction to wake up the main radio. According to one embodiment, the sleep signal may be configured as a separate sequence from the wake-up signal. According to one embodiment, the sleep signal may include information in which information to wake up the main radio is mapped from K information bits included in the wake-up signal. For example, in the case of 1 bit of information, ‘0’ may indicate OFF and ‘l’ may indicate ON.

According to various embodiments of the present disclosure, the main radio of the terminal may be turned off when a configured condition is satisfied. According to one embodiment, the condition configured for the main radio may be when the main radio cannot detect or decode a downlink control channel, a specific channel or a signal during a configured interval. According to one embodiment, the base station may configure, to the terminal, configuration information (e.g., information including an interval and a specific channel or signal) for determining to turn off the main radio through an upper layer signal indicating configuration information for reception of a wake-up signal or another upper layer signal.

According to various embodiments of the present disclosure, the main radio of the terminal may always be turned off after receiving a channel or signal. According to one embodiment, after the wake-up receiver receives a wake-up signal from the base station and the main radio is turned on to receive a channel or signal, the main radio may be turned off. According to one embodiment, a time required for the main radio to be turned off after the channel or reception is completed may be predefined. According to one embodiment, the terminal may transmit information about the time required for the main radio to be turned off to the base station, and the base station may configure the required time to the terminal on the basis of the received information. According to one embodiment, the information about the required time transmitted by the terminal may be transmitted to the base station through a UE capability information reporting procedure. According to one embodiment, the information about the required time transmitted by the terminal may be transmitted to the base station through a random access preamble or an uplink data channel. Of course, they are not limited thereto, and the terminal may transmit information about the required time to the base station through an upper layer signal. The base station may configure the information about the required time to be transmitted to the terminal through the downlink data channel of the random access response (e.g., message 2) or the random access contention resolution (e.g., message 4). Of course, without limitation thereto, the base station may configure the information about the required time to the terminal through an upper layer signal.

Hereinafter, according to various embodiments of the present disclosure, when a terminal or a main radio of the terminal is in an RRC_CONNECTED state, the terminal may be configured with C-DRX (connected mode DRX) so that the main radio may wake up every DRX cycle to perform PDCCH reception. According to one embodiment, when the terminal or the main radio of the terminal is in an RRC_CONNECTED state, the terminal (or the main radio) may be configured to receive a signal indicating whether the terminal should receive a PDCCH in the next DRX cycle.

According to one embodiment, when the main radio is in RRC_IDLE/RRC_INACTIVE state, the terminal may be configured with I-DRX (idle mode DRX) so that the main radio wakes up every paging cycle to receive a paging PDCCH. According to one embodiment, when the terminal or the main radio of the terminal is in RRC_CONNECTED state, the terminal (or the main radio) may be configured to receive a signal indicating to the terminal whether to receive a paging PDCCH in the next paging cycle.

Hereinafter, according to various embodiments of the present disclosure, an embodiment is provided for a procedure of a terminal operating as a wake-up receiver when an operation, in which ON/OFF is indicated on the basis of reception of a wake-up signal of a wake-up receiver and a main radio, and an operation according to a configuration of C-DRX or I-DRX are mixed. According to one embodiment, an operation of the terminal or the main radio of the terminal related to an RRC CONNECTED/IDLE/INACTIVE state may be performed in combination with various operations according to various embodiments of the present disclosure, or may be performed separately, and may not be an essential component.

According to various embodiments of the present disclosure, when a terminal having a wake-up receiver performs an operation of turning on and off a main radio of the terminal by receiving a wake-up signal, the terminal may not perform an configuration and an operation according to the configuration of the C-DRX or I-DRX. In this case, instead of performing the configuration and the operation according to the configuration of the C-DRX or I-DRX, the terminal may turn on the main radio of the terminal only when it receives a wake-up signal to wake up the main radio, and may receive a physical downlink control channel (PDCCH) and a physical downlink shared channel (PDSCH) defined or configured to be received in the C-DRX or I-DRX, respectively.

According to one embodiment, when a terminal or a main radio of the terminal is in RRC_CONNECTED state and an operation performed by a wake-up receiver is configured or activated by a base station, the terminal may turn on the main radio if the wake-up receiver receives a wake-up signal to wake up the main radio, and may also perform an operation related to C-DRX configured by the base station (e.g., the main radio receives a PDCCH within drx_onDurationTimer for each DRX cycle). According to one embodiment, the terminal (or the main radio) may not perform an operation configured to receive a signal (e.g., DCI format 2_6) instructing the terminal whether to receive a PDCCH in the next DRX cycle. According to one embodiment, when a terminal or a main radio of the terminal is in RRC_IDLE/INACTIVE state and an operation performed by a wake-up receiver is configured or activated by a base station, the terminal may turn on the main radio if the wake-up receiver receives a wake-up signal to wake up the main radio, and may also perform an operation related to I-DRX configured by the base station (e.g., the main radio wakes up every paging cycle to receive a paging PDCCH). According to one embodiment, the terminal (or the main radio) may not perform an operation configured to receive a signal (e.g., DCI format 2_7) indicating to the terminal whether to receive a paging PDCCH in a next paging cycle.

According to one embodiment, the terminal may perform an operation for waking up the main radio according to the wake-up receiver and the wake-up signal according to various embodiments of the present disclosure and an operation for turning off the main radio, instead of an operation according to the configuration related to C-DRX or I-DRX. In the case that the operation performed by the wake-up receiver is deactivated by the base station, the operations related to the C-DRX or I-DRX configured by the base station may be performed again.

According to various embodiments of the present disclosure, when an operation performed by a wake-up receiver of a terminal is configured or activated by a base station, and the terminal or the wake-up receiver receives a wake-up signal to turn on a main radio, the terminal may be shifted to the RRC_CONNECTED state or to the RRC_IDLE or RRC_INACTIVE state. According to an embodiment, whether the terminal may be shifted to a certain state may be determined in advance or may be determined by an upper layer signal for a wake-up receiver operation configuration or a separate upper layer signal from the base station. According to one embodiment, which state the terminal may transition to may be predetermined, or may be determined by an upper layer signal or a separate upper layer signal for configuring wake-up receiver operation from the base station.

According to one embodiment, as an example of a case where the information about the transition of the terminal (information about which RRC state the main radio will be in when the main radio is turned on by the wake-up signal) is predetermined, the state of the main radio may follow the state in which the main radio was most recently turned on and then turned off immediately before the current turn-on time. According to another embodiment, as a case where the information about the transition of the terminal is predetermined, the state of the main radio may not be affected by whether the wake-up receiver operation is configured and activated. For example, the state of the main radio of the terminal may be determined only by an upper layer signal indicating at least one of RRC_CONNECTED, RRC_IDLE or RRC_INACTIVE, and the terminal may determine that the state of the main radio is not changed by whether the wake-up receiver operation is configured and activated.

According to one embodiment, the wake-up signal may include K information bits, and information about at least one of whether the main radio is to go to RRC_CONNECTED state, RRC_IDLE state, or RRC_INACTIVE state may be mapped to the K information bits.

According to one embodiment, in the case that the terminal or the main radio of the terminal is RRC_CONNECTED on the basis of the determined state of the terminal, the main radio may wake up and receive a PDCCH for each DRX cycle by C-DRX configured by the base station, or the terminal (or the main radio) may be configured by the base station to receive a signal instructing the terminal whether to receive a PDCCH in a next DRX cycle. According to one embodiment, in the case that an operation for turning off the main radio according to various embodiments is performed while the terminal is receiving a PDCCH (e.g., during a period in which the PDCCH is received), the terminal may perform the procedure for turning off the main radio as a priority.

According to one embodiment, when the terminal or the main radio of the terminal is RRC_IDLE/INACTIVE, the main radio may wake up and receive a paging PDCCH at each paging cycle by the I-DRX configured from the base station. The terminal (or the main radio) may also be configured by the base station to receive a signal instructing the terminal whether to receive a paging PDCCH in a next paging cycle. When an operation for turning off the main radio according to various embodiments is performed while the terminal receives the paging PDCCH (e.g., during a period in which the paging PDCCH is received), the terminal may perform the procedure for turning off the main radio as a priority.

According to various embodiments of the present disclosure, the operations of the various terminals (or main radios) described above may be performed regardless of the order, and it goes without saying that the subject of the operations may be either the terminal or the main radio.

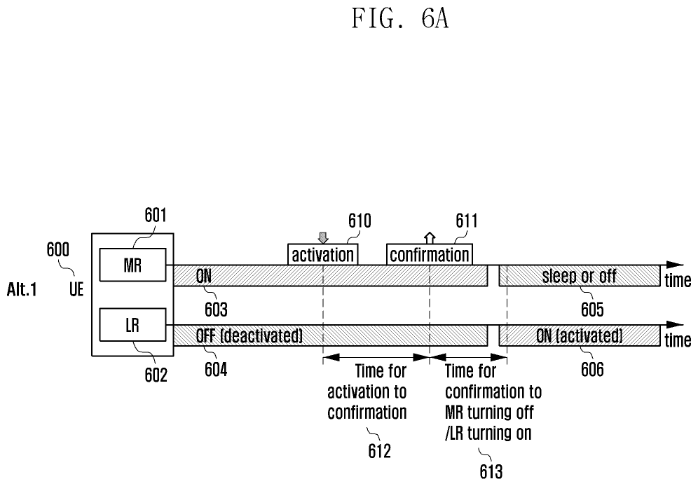

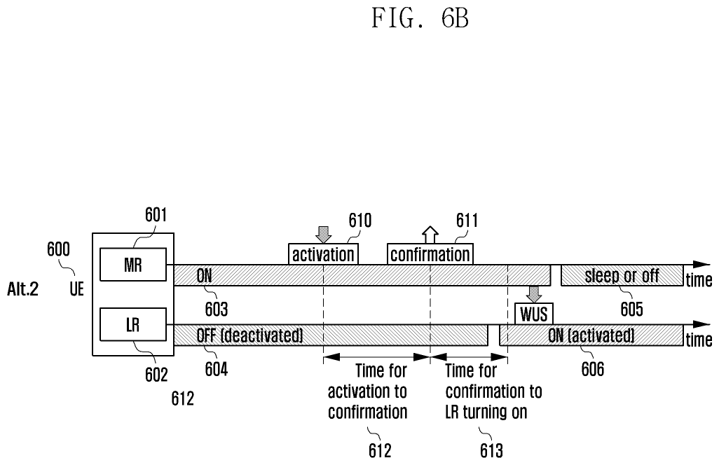

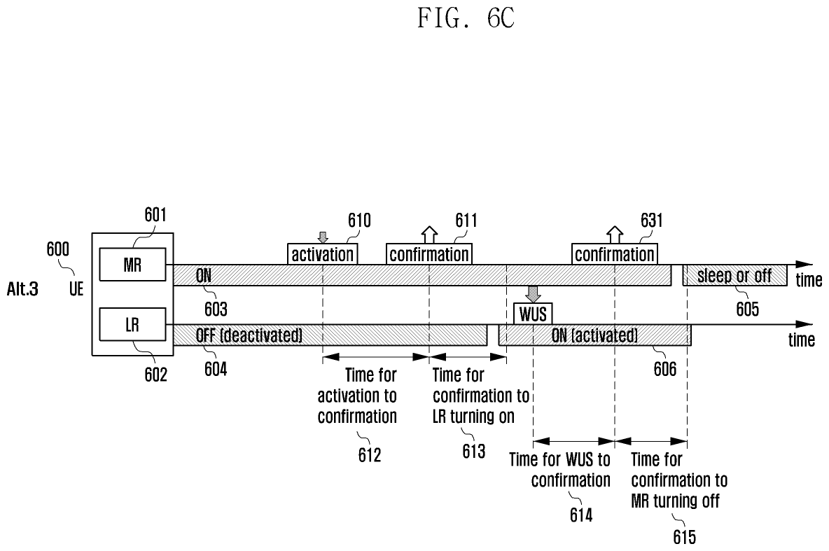

In the case that the base station transmits to the terminal instruction information activating terminal reception of a wake-up signal, and the base station and the terminal have different understandings as to when the terminal should detect the wake-up signal from the wake-up receiver and when the main radio can be turned off, even if the base station transmits to the terminal a wake-up signal receivable from the wake-up receiver and a downlink channel/signal receivable from the main radio, a problem may occur in which the terminal may miss the signals and channels. Embodiments for solving the above problems will be described with reference to FIGS. 6a to 6c, FIGS. 7, 8, and 9.

Hereinafter, according to various embodiments of the present disclosure, a procedure is described for causing a main radio to go to sleep until a wake-up signal is received and activating a wake-up receiver to detect the wake-up signal. At this time, a procedure for a base station and a terminal having the wake-up receiver to transmit and receive a signal indicating the activation and a response signal corresponding thereto, and a possible solution in the case that the signals are missed, are described. The signal indicating the activation may be transmitted through wake-up reception configuration information, that is, a signal indicating whether the wake-up receiver is used or configuration information for receiving the wake-up signal, or the wake-up reception configuration information may be determined by the terminal as the signal indicating the activation. Alternatively, it may be transmitted separately from the wake-up reception configuration information.

According to another embodiment, a procedure is described for turning on a main radio to transmit and receive signals without relying on a wake-up receiver any longer, and deactivating the wake-up receiver so that the wake-up receiver no longer detects a wake-up signal. In this case, a procedure for a base station and a terminal having the wake-up receiver to transmit and receive a signal instructing the deactivation and a response signal corresponding thereto, and a possible solution in the case that the signals are missed are described. The signal instructing the deactivation may be transmitted through wake-up reception deconfiguration information, that is, a signal for deconfiguring whether the wake-up receiver is used or for deconfiguring reception of a wake-up signal, or the wake-up reception deconfiguration information may be determined by the terminal as the signal indicating the deactivation. Alternatively, it may be transmitted separately from the wake-up reception deconfiguration information.

In describing the embodiments below, it should be noted that operations or procedures expressed as being performed by a main radio or a wake-up receiver for a terminal equipped with a wake-up receiver (i.e., a terminal having the capability of wake-up reception) may also be understood as being performed by the terminal equipped with the wake-up receiver (i.e., a terminal having the capability of wake-up reception).

First, a procedure is described that causes the main radio to go into a sleep state until a wake-up signal is received through FIGS. 6a to 6c and activates the wake-up receiver to detect the wake-up signal.

FIGS. 6a to 6c illustrates an example for activating a wake-up receiver according to various embodiments of the present disclosure. The embodiments below are applicable when a terminal is in an RRC CONNECTED state, and a method applicable when the terminal is in an RRC IDLE or RRC INACTIVE state will be additionally described.

In the first embodiment, the terminal 600 is equipped with a wake-up receiver 602 as well as a main radio 601, and it may be assumed that the exchange of wake-up related capability information of the terminal 600 and the configuration information for receiving a wake-up signal from the base station have already been performed by the method described above in the present invention. The main radio 601 of the terminal 600 is turned on in 603, and the wake-up receiver is turned off in a deactivated state in 604. The base station may transmit a signal 610 to activate the wake-up receiver, and the terminal 600 may transmit a response 611 to the signal 610 after a certain period of time 612 after receiving the signal 610. After transmitting the response 611, after a certain period of time 613, the terminal 600 may turn off the main radio 605 and activate the wake-up receiver in the on state 606 to start searching for a wake-up signal. The times corresponding to 612 and 613 may be defined in the standard or may be configured to the terminal through an upper layer signal. In particular, the time for turning off the main radio in 613 and the time for activating the wake-up receiver in the on state may be defined separately in the standard, or only one of the two may be defined in the standard or may be configured to the terminal through an upper layer signal.

When the terminal (or main radio) is in RRC IDLE or RRC INACTIVE state, it may receive a signal 610 to activate the wake-up receiver without transmitting the response 611, and after a certain period of time 612, the main radio is turned off 605, the wake-up receiver is turned on and activated 606, and the search for a wake-up signal may begin.

In the first embodiment, when the base station does not receive the response 611, the base station may retransmit a signal 610 to activate the wake-up receiver again to the main radio of the terminal, or may transmit a downlink signal directly to the main radio of the terminal instead of waking up the main radio of the terminal by transmitting the wake-up signal. In this case, there may be a problem that the terminal (or the main radio of the terminal) may miss the downlink signal transmitted by the base station because the main radio of the terminal is already in the off state 605 in the first embodiment. A second embodiment for solving the problem will be described.

In the second embodiment, the process up to transmitting the response 611 is the same as the first embodiment, whereas after transmitting the response 611, after a certain period of time 613, the terminal 600 may start searching for a wake-up signal by activating only the wake-up receiver in an on state 606 without turning off the main radio, and may receive the first wake-up signal 620. The wake-up signal may be determined by the terminal 600 as feedback that the base station has properly received the response 611, and the terminal 600 may turn off the main radio after a certain period of time after receiving the wake-up signal. In the case that the wake-up signal is not received for a certain period of time after turning on the wake-up receiver, the main radio may be maintained in an on state without turning off. In addition, the wake-up receiver may be changed to a deactivated off state, and the procedure may be initialized to receive the activation signal 610 again. The period of time from sending the response 611 to receiving the first wake-up signal 620 may be defined in the standard or may be configured to the terminal through an upper layer signal. In the second embodiment, if the base station transmits the first wake-up signal but the terminal does not receive the first wake-up signal, the terminal may retransmit the response 611 from the main radio or attempt to receive the downlink signal or the activation signal 610 directly from the main radio. Since the base station will re-receive the response 611 and re-transmit the wake-up signal 620, the terminal may re-receive the wake-up signal 620 transmitted by the base station. At this time, a situation may occur where the terminal needs to retransmit the response 611 from the main radio. Considering this situation, the terminal may turn off the main radio after receiving the general downlink signal after receiving the second wake-up signal (a wake-up signal transmitted to the wake-up receiver to turn on the main radio to receive a general downlink signal).

In the third embodiment, the process up to receiving the first wake-up signal 620 is the same as the second embodiment, whereas after receiving the wake-up signal 620, a response 631 to the wake-up signal 620 is transmitted after a certain period of time 614, so that the base station can determine that the terminal has successfully received the wake-up signal 620. After transmitting the response 631, the terminal may finally turn off the main radio after a certain period of time 615. In the case that the base station does not receive the response 631, the first wake-up signal 620 may be retransmitted, and the terminal may transmit the response 631 again after receiving the first wake-up signal 620. A certain period of time from receiving the first wake-up signal to transmitting a response 631 and a certain period of time from sending a response 631 to turning off the main radio may be defined in the standard or may be configured to the terminal through an upper layer signal.

In the above embodiments, the first wake-up signal may include information that it is necessary to activate the wake-up receiver, and may be configured with a different sequence from other general wake-up signals for turning on the main radio to receive a general downlink signal. In this case, when the terminal receives the first wake-up signal or another general wake-up signal from the wake-up receiver, the terminal may determine that the main radio is to be woken up, and may turn on the main radio. When the first wake-up signal is received, the response 631 may be transmitted from the terminal or the main radio of the terminal, and when a general wake-up signal different from the first wake-up signal is received, the general downlink signal may be received from the terminal or the main radio of the terminal.

In the each of the above embodiments, some signals may be omitted or the order of the signals may be changed.

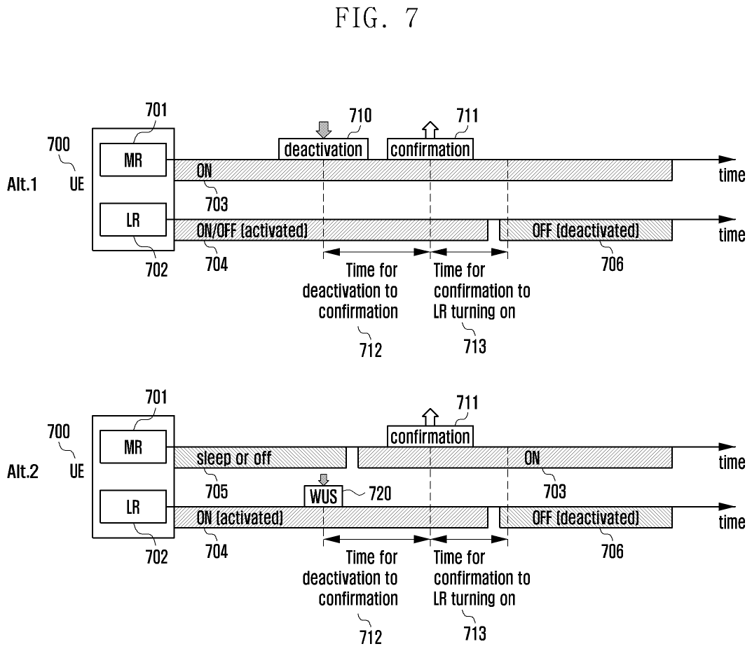

Next, a procedure is described in FIG. 7 to disable the wake-up receiver so that it no longer detects the wake-up signal and the main radio may continue with its normal terminal operations without relying on the wake-up receiver.

FIG. 7 illustrates an example for deactivating a wake-up receiver according to various embodiments of the present disclosure. The embodiments below are applicable when a terminal is in an RRC CONNECTED state, and a method applicable when a terminal is in an RRC IDLE or RRC INACTIVE state will be additionally described.

In the first embodiment, the terminal 700 is equipped with a wake-up receiver 702 as well as a main radio 701, and it may be assumed that the exchange of wake-up related capability information of the terminal 700 and the configuration information for receiving a wake-up signal from the base station have already been performed by the method described above in the present invention. The main radio 701 of the terminal 700 may be in an on state (or a sleep or off state) in 703, and the wake-up receiver may be in an on or off state while being activated in 704. In the first embodiment, the deactivation signal 710 is received through the main radio. First, the base station transmits a signal 710 for deactivating the wake-up receiver. In the case that the main radio 701 is in a sleep or off state, the base station may transmit a wake-up signal to trigger the main radio 701 to be in an on state, and then transmit a signal 710 for deactivating the wake-up receiver. The terminal 700 may transmit a response 711 to the signal 710 after a certain period of time 712 after receiving the signal 710 through the main radio. After transmitting the response 711, the terminal 700 may maintain the main radio in an on state 703 and deactivate the wake-up receiver in an off state 706 so as to no longer search for the wake-up signal after a certain period of time 713. As another example, the terminal 700 may deactivate the wake-up receiver in an off state after a certain period of time 712 after receiving the signal 710, and thereafter transmit a response 711 to the signal 710. In this case, the certain period of time 712 may be defined as the time from when the deactivation instruction is received until the wake-up receiver is deactivated.

In the case that the terminal misses the deactivation 710 signal, the terminal may not transmit a response 711 to the deactivation signal 710. In this case, since the base station may not receive the response 711, the base station may retransmit the deactivation signal 710 again, and the terminal may re-receive the deactivation 710 signal. In the case that the base station misses the response 711, the base station determines that the terminal did not receive the deactivation signal 710 and may retransmit the deactivation signal 710. In this case, the terminal may re-receive the deactivation 710 signal and re-transmit the response 711 to the base station.

The times corresponding to 712 and 713 above may be defined in the standard or may be configured to the terminal through an upper layer signal.

When the terminal (or main radio) is in the RRC IDLE or RRC INACTIVE state, a signal 710 for deactivating the wake-up receiver may be received without transmitting the response 711, and after a certain period of time 712, the wake-up receiver may be deactivated in the off state 706, thereby stopping the search for the wake-up signal.

In the second embodiment, the terminal 700 is equipped with a wake-up receiver 702 as well as a main radio 701, and it may be assumed that the exchange of wake-up related capability information of the terminal 700 and the configuration information for receiving a wake-up signal from the base station have already been performed by the method described above in the present invention. The main radio 701 of the terminal 700 may be in a sleep or off state in 705, and the wake-up receiver may be turned on and activated in 704. In the second embodiment, a deactivation signal 720 is received through the wake-up receiver. First, the base station transmits a signal 720 for deactivating the wake-up receiver through the wake-up signal. At this time, the wake-up signal may include deactivation information. The terminal 700 may trigger the main radio to be turned on after receiving the signal 720 through the wake-up receiver 702, and transmit a response 711 to the signal 720 through the main radio after a certain period of time 712. After transmitting the response 711, the terminal 700 may maintain the main radio in the on state 703 and deactivate the wake-up receiver to be turned off 706 so as to no longer search for the wake-up signal. As another example, the terminal 700 may deactivate the wake-up receiver to be turned off after a certain period of time 712 after receiving the signal 720, and thereafter transmit a response 711 to the signal 720. In this case, the certain period of time 712 may be defined as the time from the reception of the deactivation instruction to the deactivation of the wake-up receiver. The times corresponding to 712 and 713 above may be defined in the standard or may be configured to the terminal through an upper layer signal.

When the terminal (or main radio) is in the RRC IDLE or RRC INACTIVE state, a signal 720 for deactivating the wake-up receiver may be received without transmitting the response 711, and after a certain period of time 712, the wake-up receiver may be deactivated in the off state 706, thereby stopping the search for the wake-up signal.

When the terminal (or main radio) is in RRC IDLE or RRC INACTIVE state, the signal to activate or deactivate the wake-up receiver may be transmitted as an upper layer signal containing system information, or it may be included in a signal indicating paging.

When a terminal changes from an RRC IDLE or RRC INACTIVE state to an RRC CONNECTED state by a signal from a base station, or changes from an RRC CONNECTED state to an RRC IDLE or RRC INACTIVE state, it may be determined that the activation instruction reception of the wake-up receiver in the previous state is no longer valid. For example, even if the wake-up receiver was activated in the previous RRC IDLE or RRC INACTIVE state, the terminal may determine that the activation of the wake-up receiver is inactive until an activation instruction of the wake-up receiver is received from the base station in the changed RRC CONNECTED state, turn off the wake-up receiver to the inactive state, and change the main radio to the on state to perform data transmission and reception through the main radio.

In another embodiment, when a terminal changes from an RRC IDLE or RRC INACTIVE state to an RRC CONNECTED state by a signal from a base station, or changes from an RRC CONNECTED state to an RRC IDLE or RRC INACTIVE state, it may be determined that the activation instruction reception of the wake-up receiver in the previous state is still valid. For example, if the wake-up receiver was in the activated state in the previous RRC CONNECTED state, the terminal may determine that the activation state of the wake-up receiver is maintained even if there is no separate activation instruction of the wake-up receiver from the base station in the changed RRC IDLE or RRC INACTIVE state, maintain the wake-up receiver in the activated state, and change or maintain the main radio in the sleep or off state to search for a wake-up signal through the wake-up receiver. In this case, the base station may change the activation/deactivation of the wake-up receiver in advance in the previous RRC state of the terminal according to the activation/deactivation situation of the wake-up receiver in the changed RRC state of the terminal.

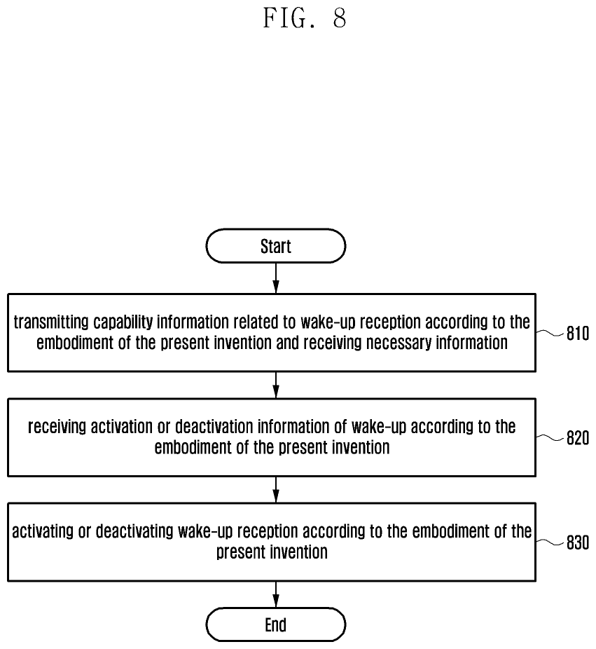

FIG. 8 illustrates an operation flow of a terminal for activating a wake-up receiver according to various embodiments of the present disclosure. Various embodiments of the present disclosure may include at least one of all, some, or a combination of some of the steps described below, and it goes without saying that not only all of the steps of FIG. 8, but also each of the steps of FIG. 8 may bring about the effects sought to be obtained by the present disclosure. In addition, the steps illustrated in FIG. 8 may be one example for one embodiment of the present disclosure, and various embodiments of the present disclosure performed by the terminal (or the main radio) are not limited thereto.

In step 810, the terminal may transmit capability information related to wake-up reception to the base station and receive information necessary for wake-up reception. According to one embodiment, the terminal including the wake-up receiver may report to the base station that it has the capability to wake up the main radio using the wake-up receiver or may report capability information that the terminal includes the wake-up receiver to the base station. According to one embodiment, the terminal may also report capability information about the wake-up receiver to the base station through a UE capability information reporting procedure. According to one embodiment, the terminal may receive configuration information necessary for wake-up reception from the base station, such as necessary period information for the wake-up receiver to search for a wake-up signal, information on whether to always perform a search, resource information necessary for the search, etc.

In step 820, the terminal may receive activation information instructing data transmission and reception through wake-up from the base station or deactivation information instructing no more data transmission and reception through wake-up. According to one embodiment, the terminal may perform subsequent procedures according to the method proposed in the present invention, such as transmitting a response signal after a certain period of time after receiving the wake-up activation or deactivation information.

In step 830, the terminal may activate or deactivate wake-up reception on the basis of the activation or deactivation instruction in step 820. According to one embodiment, the terminal may activate or deactivate wake-up reception and perform subsequent procedures according to the method proposed in the present invention, such as transmitting a response signal after a certain period of time.

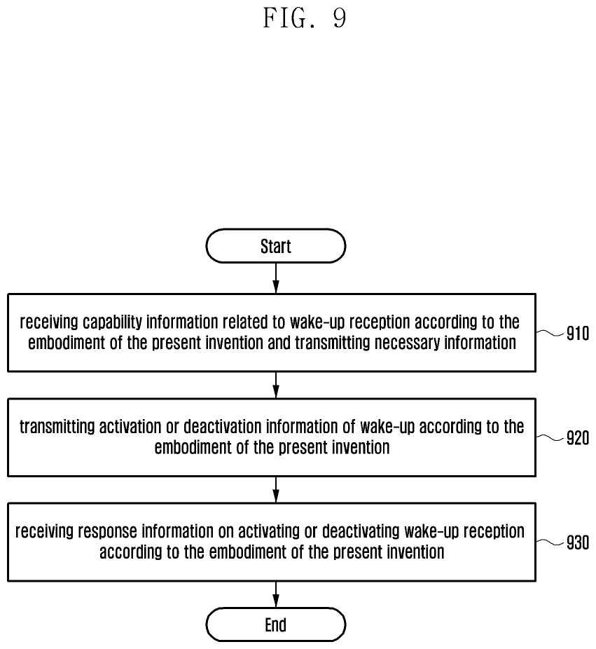

FIG. 9 illustrates an operation flow of a base station for transmitting a wake-up signal according to various embodiments of the present disclosure. Various embodiments of the present disclosure may include at least one of all, some, or a combination of some of the steps described below, and it goes without saying that not only all of the steps of FIG. 7, but also each of the steps of FIG. 9 may bring about the effects sought to be obtained by the present disclosure. In addition, the steps illustrated in FIG. 9 may be an example for one embodiment of the present disclosure, and various embodiments of the present disclosure performed by the base station are not limited thereto.

In step 910, the base station may receive capability information related to wake-up reception from the terminal and transmit information necessary for wake-up reception. According to one embodiment, the base station may receive capability information of waking up the main radio using the wake-up receiver from the terminal including the wake-up receiver or capability information that the terminal includes the wake-up receiver. According to one embodiment, the base station may also receive capability information about the wake-up receiver from the terminal through a UE capability information reporting procedure. According to one embodiment, the base station may transmit configuration information necessary for wake-up reception to the terminal, such as necessary period information for the wake-up receiver to search for a wake-up signal, information on whether to always perform a search, resource information necessary for the search, etc.

In step 920, the base station may transmit activation information to the terminal to instruct data transmission and reception through wake-up or deactivation information to no longer perform data transmission and reception through wake-up.

In step 930, the base station may receive response information on activating or deactivating wake-up reception on the basis of the activation or deactivation instruction in step 920. According to one embodiment, the base station may perform subsequent procedures according to the method proposed in the present invention, such as receiving a response signal in step 930, after a certain period of time from the time when it is determined that the terminal has received the wake-up activation or deactivation information.

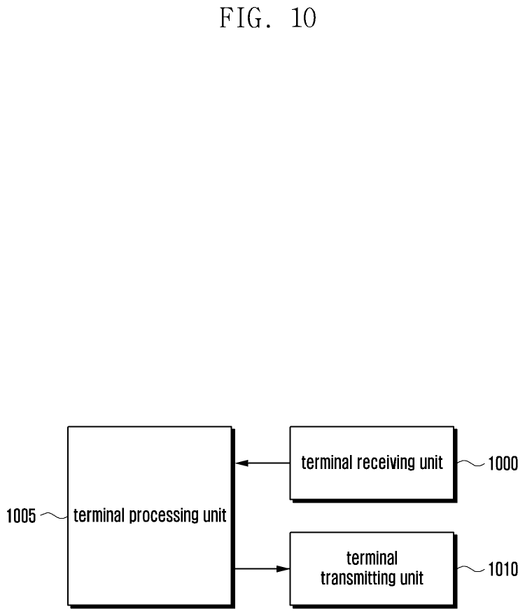

FIG. 10 is a diagram illustrating the structure of a terminal in a wireless communication system according to various embodiments of the present disclosure.

With reference to FIG. 10, the terminal may include a transceiver, which refers to a terminal receiving unit 1000 and a terminal transmitting unit 1010, a memory (not shown), and a terminal processing unit 1005 (or a terminal control unit or processor). According to the communication method of the terminal described above, the transceiver 1000 and 1010, the memory, and the terminal processing unit 1005 of the terminal may operate. However, the components of the terminal are not limited to the examples described above. For example, the terminal may include more or fewer components than the components described above. In addition, the transceiver, the memory, and the processor may be implemented in the form of a single chip.

The transceiver 1000 and 1010 may transmit and receive signals with the base station. Here, the signals may include control information and data. To this end, the transceiver may be configured with an RF transmitter that up-converts and amplifies the frequency of a transmitted signal, an RF receiver that low-noise amplifies a received signal and down-converts the frequency, etc. However, this is only one embodiment of the transceiver, and the components of the transceiver are not limited to the RF transmitter and the RF receiver.

In addition, the transceiver 1000 and 1010 may receive a signal through a wireless channel and output it to the terminal processing unit 1005, and transmit a signal output from the terminal processing unit 1005 through the wireless channel.

The memory may store programs and data necessary for the operation of the terminal. In addition, the memory may store control information or data included in signals transmitted and received by the terminal. The memory may be composed of a storage medium such as ROM, RAM, a hard disk, CD-ROM, and DVD, or a combination of storage media. In addition, there may be a plurality of memories.

In addition, the terminal processing unit 1005 may control a series of processes so that the terminal can operate according to the above-described embodiment. There may be a plurality of terminal processing units 1005, and the terminal processing units 1005 may perform component control operations of the terminal by executing a program stored in a memory.

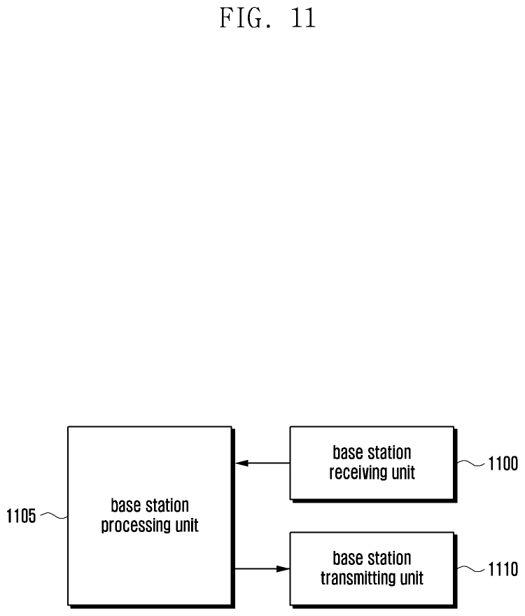

FIG. 11 is a diagram illustrating the structure of a base station in a wireless communication system according to various embodiments of the present disclosure.

With reference to FIG. 11, the base station may include a transceiver, which refers to a base station receiving unit 1100 and a base station transmitting unit 1110, a memory (not shown), and a base station processing unit 1105 (or a base station control unit or processor). According to the communication method of the base station described above, the transceiver 1100 and 1110, the memory, and the base station processing unit 1105 of the base station may operate. However, the components of the base station are not limited to the examples described above. For example, the base station may include more or fewer components than the components described above. In addition, the transceiver, the memory, and the processor may be implemented in the form of a single chip.

The transceiver 1100 and 1110 may transmit and receive signals with the terminal. Here, the signals may include control information and data. To this end, the transceiver may be configured with an RF transmitter that up-converts and amplifies the frequency of a transmitted signal, an RF receiver that low-noise amplifies a received signal and down-converts the frequency, etc. However, this is only one embodiment of the transceiver, and the components of the transceiver are not limited to the RF transmitter and the RF receiver.

In addition, the transceiver 1100 and 1110 may receive a signal through a wireless channel and output it to the base station processing unit 1105, and transmit a signal output from the base station processing unit 1105 through the wireless channel.

The memory may store programs and data required for the operation of the base station. In addition, the memory may store control information or data included in signals transmitted and received by the base station. The memory may be composed of a storage medium or a combination of storage media such as a ROM, a RAM, a hard disk, a CD-ROM, and a DVD. In addition, there may be a plurality of memories.

The base station processing unit 1105 may control a series of processes so that the base station can operate according to the embodiment of the present disclosure described above. There may be a plurality of base station processing units 1105, and the base station processing units 1105 may perform component control operations of the base station by executing a program stored in a memory.

The methods according to the embodiments described in the claims or specification of the present disclosure may be implemented in the form of hardware, software, or a combination of hardware and software.

In the case of software implementation, a computer-readable storage medium storing one or more programs (software modules) may be provided. The one or more programs stored in the computer-readable storage medium are configured for execution by one or more processors in an electronic device. The one or more programs include instructions that cause the electronic device to execute methods according to the embodiments described in the claims or specification of the present disclosure.

These programs (software modules, software) may be stored in a non-volatile memory including a random access memory, a flash memory, a ROM (Read Only Memory), an Electrically Erasable Programmable Read Only Memory (EEPROM), a magnetic disc storage device, a Compact Disc-ROM (CD-ROM), a Digital Versatile Discs (DVDs) or other forms of optical storage devices, a magnetic cassette. Or, they may be stored in a memory composed of a combination of some or all of these. In addition, each configuration memory may be included in multiple numbers.

Additionally, the program may be stored in an attachable storage device that is accessible through a communications network, such as the Internet, an Intranet, a Local Area Network (LAN), a Wide LAN (WLAN), or a Storage Area Network (SAN), or a combination thereof. The storage device may be connected to a device performing an embodiment of the present disclosure through an external port. Additionally, a separate storage device on the communications network may be connected to a device performing an embodiment of the present disclosure.

In the specific embodiments of the present disclosure described above, the components included in the invention are expressed in the singular or plural form according to the specific embodiments presented. However, the singular or plural expressions are selected appropriately for the presented situation for the convenience of explanation, and the present disclosure is not limited to the singular or plural components, and even if a component is expressed in the plural form, it may be composed of the singular form, or even if a component is expressed in the singular form, it may be composed of the plural form.

Meanwhile, the embodiments of the present disclosure disclosed in this specification and drawings are only specific examples to easily explain the technical contents of the present disclosure and to help understanding of the present disclosure, and are not intended to limit the scope of the present disclosure. In other words, it is obvious to a person having ordinary skill in the art to which the present disclosure pertains that other modified examples on the basis of the technical idea of the present disclosure are possible. In addition, each of the above embodiments may be combined and operated as needed. For example, parts of one embodiment of the present disclosure and parts of another embodiment may be combined and operated to operate a base station and a terminal. For example, parts of the first to third embodiments of the present disclosure may be combined and operated to operate a base station and a terminal. In addition, although the above embodiments have been presented on the basis of an FDD LTE system, other modified examples on the basis of the technical idea of the above embodiments may be implemented in other systems such as a TDD LTE system, a 5G or NR system.

Meanwhile, the order of description in the drawings explaining the method of the present invention does not necessarily correspond to the order of execution, and the order of precedence may be changed or executed in parallel.

Alternatively, the drawings illustrating the method of the present invention may omit some components and include only some components without impairing the essence of the present invention.

In addition, the method of the present invention may be implemented by combining some or all of the contents included in each embodiment within a scope that does not impair the essence of the invention.

Various embodiments of the present disclosure have been described above. The above description of the present disclosure is for illustrative purposes only, and the embodiments of the present disclosure are not limited to the disclosed embodiments. Those skilled in the art to which the present disclosure pertains will understand that the present disclosure may be easily modified into other specific forms without changing the technical idea or essential features of the present disclosure. The scope of the present disclosure is indicated by the claims described below rather than the detailed description above, and all changes or modifications derived from the meaning and scope of the claims and their equivalent concepts should be interpreted as being included in the scope of the present disclosure.

1. A method performed by a terminal of a wireless communication system, the method comprising:
receiving an activation signal for activating a wake-up receiver from a base station on the basis of a main radio (MR);
activating the wake-up receiver after receiving the activation signal; and
switching the main radio into a sleep state after receiving the activation signal.

2. The method of claim 1, further comprising transmitting a first response signal to the activation signal to the base station on the basis of the main radio, wherein
the main radio switches into a sleep state after transmitting the first response signal.

3. The method of claim 1, further comprising:
transmitting a first response signal to the activation signal to the base station on the basis of the main radio; and
receiving a wake-up signal (WUS) on the basis of the wake-up receiver after transmitting the first response signal, wherein
the main radio switches into a sleep state after receiving the WUS.

4. The method of claim 1, further comprising:
transmitting a first response signal to the activation signal to the base station on the basis of the main radio;
receiving a wake-up signal (WUS) on the basis of the wake-up receiver after transmitting the first response signal; and
transmitting a second response signal to the WUS to the base station on the basis of the main radio, wherein
the main radio switches into a sleep state after transmitting the second response signal.

5. The method of claim 1, further comprising:
receiving a deactivation signal for deactivating the wake-up receiver from the base station on the basis of the main radio; and
transmitting a third response signal to the deactivation signal to the base station on the basis of the main radio, wherein
the wake-up receiver is deactivated after transmitting the third response signal.

6. The method of claim 5, wherein, when the terminal is in a radio resource control (RRC) IDLE or RRC INACTIVE state, the wake-up receiver is deactivated without transmitting the third response signal to the deactivation signal.

7. The method of claim 1, further comprising:
receiving a wake-up signal (WUS) for deactivating the wake-up receiver from the base station on the basis of the wake-up receiver;
switching the main radio into an on state according to the WUS; and
transmitting a fourth response signal to the WUS to the base station on the basis of the main radio, wherein
the wake-up receiver is deactivated after a certain period of time from the transmission of the fourth response signal.

8. The method of claim 7, wherein, when the terminal is in a radio resource control (RRC) IDLE or RRC INACTIVE state, the wake-up receiver is deactivated without transmitting the fourth response signal to the WUS.

9. A terminal of a wireless communication system comprising:
a transceiver; and
a control unit configured to:
receive an activation signal for activating a the wake-up receiver from the base station on the basis of the main radio (MR);
activate the wake-up receiver after receiving the activation signal; and
switch the main radio into a sleep state after receiving the activation signal.

10. The terminal of claim 9, wherein
the control unit is configured to transmit a first response signal to the activation signal to the base station on the basis of the main radio, and the main radio switches into a sleep state after transmitting the first response signal.

11. The terminal of claim 9, wherein
the control unit is configured to:
transmit a first response signal to the activation signal to the base station on the basis of the main radio; and
receive a wake-up signal (WUS) on the basis of the wake-up receive after transmit the first response signal, wherein
the main radio switches into a sleep state after receiving the WUS.

12. The terminal of claim 9, wherein
the control unit is configured to:
transmit a first response signal to the activation signal to the base station on the basis of the main radio;
receive a wake-up signal (WUS) on the basis of the wake-up receiver after transmitting the first response signal; and
transmit a second response signal to the WUS to the base station on the basis of the main radio, wherein
the main radio switches into a sleep state after transmitting the second response signal.

13. The terminal of claim 9, wherein
the control unit is configured to:
receive a deactivation signal for deactivating the wake-up receiver from the base station on the basis of the main radio; and
transmit a third response signal to the deactivation signal to the base station on the basis of the main radio, wherein
the wake-up receiver is deactivated after transmitting the third response signal.

14. The terminal of claim 13, wherein, when the terminal is in a radio resource control (RRC) IDLE or RRC INACTIVE state, the wake-up receiver is deactivated without transmitting the third response signal to the deactivation signal.

15. The terminal of claim 9, wherein
the control unit is further configured to:
receive a wake-up signal (WUS) for deactivating the wake-up receiver from the base station on the basis of the wake-up receiver,
switch the main radio into an on state according to the above WUS; and
transmit a fourth response signal to the WUS to the base station on the basis of the main radio, wherein
the wake-up receiver is deactivated after a certain period of time from the transmission of the fourth response signal.
